(19) United States
(12) Patent Application Publication
(10) Pub. No.: US 2024/0305347 A1
(43) Pub. Date: Sep. 12, 2024

(54) METHOD AND APPARATUS FOR ENERGY SAVINGS OF COMMUNICATION SYSTEM

(71) Applicant: SAMSUNG ELECTRONICS CO., LTD., Suwon-si (KR)

(72) Inventors: Junyung YI, Suwon-si (KR); Youngbum KIM, Suwon-si (KR); Kyoungmin PARK, Suwon-si (KR); Youngrok JANG, Suwon-si (KR)

(21) Appl. No.: 18/601,684

(22) Filed: Mar. 11, 2024

(30) Foreign Application Priority Data
Mar. 10, 2023 (KR) 10-2023-0031867

(51) Int. Cl. H04B 7/06; H04B 17/318; H04W 52/36

(52) U.S. Cl. CPC H04B 7/0626; H04B 7/0632; H04B 17/328; H04W 52/36

(57) ABSTRACT

The disclosure relates to a 5G or 6G communication system for supporting a higher data transmission rate. A method performed by a base station in a communication system includes transmitting, to a user equipment (UE), a configuration of a channel state information (CSI) report, wherein the CSI report includes a plurality of subsets of CSI reference signal (CSI-RS) antenna ports; receiving, from the UE, the CSI report including at least one measurement value associated with at least one subset among the plurality of subsets; and identifying a number of activated transmitter receiver units (TXRUs) based on the at least one measurement value.

### CROSS REFERENCE TO RELATED APPLICATION

The present application claims priority to Korean Patent Application No. 10-2023-0031867, filed on Mar. 10, 2023, the entire contents of which is incorporated herein for all purposes by this reference.

### BACKGROUND

### 1. Field

The disclosure relates to the operation of a terminal and base station in a communication system. Specifically, the disclosure relates to a method and apparatus for energy saving in a wireless communication system.

### 2. Description of Related Art

5^{th} generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the recent development of 5G/6G communication systems that consider the environment, a need for methods to reduce energy consumption of communication systems (e.g., terminals, base stations, networks, etc.) or methods for energy saving is emerging.

### SUMMARY

An embodiment of the disclosure may provide a spatial domain adaptation (SD adaptation) method of a base station in a wireless communication system.

An embodiment of the disclosure may provide an SD adaptation method for turning off the spatial and power elements (e.g., including one or more of an antenna element (AE), power amplifier (PA), antenna port, and antenna panel) of a base station.

An embodiment of the disclosure may provide a method for efficient channel state information (CSI) resource and CSI resource set configurations and CSI report configuration through higher layer signaling (e.g., radio resource control (RRC) signaling) to apply SD adaptation.

An embodiment of the disclosure may provide a CSI measurement and CSI reporting method of a terminal based on the configured CSI resource and CSI resource set, and CSI report configuration.

The technical objects to be achieved by the disclosure are not limited to the technical objects mentioned above, and other technical objects not mentioned may be clearly understood by those skilled in the art from the following descriptions.

According to an embodiment, a method performed by a base station in a communication system may be provided.

According to an embodiment, the method may include configuring CSI resources (and/or CSI resource sets) and/or CSI report having/including multiple antenna configuration hypotheses for spatial domain (SD) and/or power domain (PD) adaptation through higher layer signaling.

According to an embodiment, the method may include determining the configuration of the CSI report among multiple antenna configuration hypotheses based on the configured information.

According to an embodiment, the method may include receiving the CSI report having/including the multiple antenna configuration hypotheses from the terminal.

According to an embodiment, the method may include applying SD and/or PD adaptation based on the CSI report received from the terminal.

According to an embodiment, the SD and/or PD adaptation may be for energy saving of the base station.

According to an embodiment, a method performed by a terminal in a communication system may be provided.

According to an embodiment, the method may include receiving configuration for CSI resources (and/or CSI resource sets) and/or CSI reports with multiple antenna configuration hypotheses for SD and/or PD adaptation through higher layer signaling.

According to an embodiment, the method may include determining antenna configuration hypotheses configuration for the CSI report among multiple antenna configuration hypotheses based on the configured information.

According to an embodiment, the method may include transmitting the CSI report having/including the multiple antenna configuration hypotheses.

According to an embodiment, the method may include receiving the configurations for SD and PD adaptation from the base station.

According to an embodiment, the SD and/or PD adaptation may be for energy saving of the base station.

According to an embodiment of the disclosure, an SD adaptation method for turning off the spatial element of a base station and a CSI report method based on thresholding of a terminal in a mobile communication system in a 5G system may be provided.

An embodiment of the disclosure may provide a method performed by a base station in a communication system including transmitting, to a user equipment (UE), a configuration of a channel state information (CSI) report, wherein the CSI report includes a plurality of subsets of CSI reference signal (CSI-RS) antenna ports; receiving, from the UE, the CSI report including at least one measurement value associated with at least one subset among the plurality of subsets; and identifying a number of activated transmitter receiver units (TXRUs) based on the at least one measurement value.

An embodiment of the disclosure, wherein a number of the at least one subset is based on a capability of the UE for a CSI processing unit (CPU) associated with the CSI report.

An embodiment of the disclosure, wherein the configuration includes a plurality of power control offsets corresponding to the plurality of subsets.

An embodiment of the disclosure, wherein a power control offset is configured for a measurement value associated with a subset corresponding to the power control offset.

An embodiment of the disclosure, wherein the number of activated TXRUs is identified based on: adjusting a number of antenna ports with maintaining a number of activated physical antenna elements per antenna port in case that the base station in case that the base station is configured to operate in a mode 1, adjusting a number of activated physical antenna elements with maintaining the number of antenna ports in case that the base station in case that the base station is configured to operate in a mode 2.

An embodiment of the disclosure, wherein the configuration includes information associated with whether the base station is configured to operate in the mode 1 or the mode 2.

An embodiment of the disclosure, wherein the at least one measurement value is one of reference signal received power (RSRP), reference signal received quality (RSRQ), or a channel quality indicator (CQI).

An embodiment of the disclosure, a base station in a communication system is provided. An embodiment of the disclosure, the base station may include a transceiver; and a processor coupled with the transceiver and configured to: transmit, to a user equipment (UE), a configuration of a channel state information (CSI) report, wherein the CSI report includes a plurality of subsets of CSI reference signal (CSI-RS) antenna ports; receive, from the UE, the CSI report including at least one measurement value associated with at least one subset among the plurality of subsets; and identify a number of activated transmitter receiver units (TXRUs) based on the at least one measurement value.

An embodiment of the disclosure, wherein a number of the at least one subset is based on a capability of the UE for a CSI processing unit (CPU) associated with the CSI report.

An embodiment of the disclosure, wherein the configuration includes a plurality of power control offsets corresponding to the plurality of subsets.

An embodiment of the disclosure, wherein a power control offset is configured for a measurement value associated with a subset corresponding to the power control offset.

An embodiment of the disclosure, wherein the number of activated TXRUs is identified based on: adjusting a number of antenna ports with maintaining a number of activated physical antenna elements per antenna port in case that the base station in case that the base station is configured to operate in a mode 1, adjusting a number of activated physical antenna elements with maintaining the number of antenna ports in case that the base station in case that the base station is configured to operate in a mode 2.

An embodiment of the disclosure, wherein the configuration includes information indicating whether the base station is configured to operate in the mode 1 or the mode 2.

An embodiment of the disclosure, wherein the at least one measurement value is one of reference signal received power (RSRP), reference signal received quality (RSRQ), or a channel quality indicator (CQI).

An embodiment of the disclosure, a method performed by a user equipment (UE) in a communication system may be provided.

An embodiment of the disclosure, the method may include: receiving, from a base station, a configuration of a channel state information (CSI) report, wherein the CSI report includes a plurality of subsets of CSI reference signal (CSI-RS) antenna ports; obtaining at least one measurement value associated with at least one subset among the plurality of subsets; and transmitting, to the base station, the CSI report including the at least one measurement value, wherein the at least one measurement value is associated with a number of activated transmitter receiver units (TXRUs) of the base station.

An embodiment of the disclosure, wherein a number of the at least one subset is identified based on a capability of the UE for a CSI processing unit (CPU) associated with the CSI report.

An embodiment of the disclosure, wherein the configuration includes a plurality of power control offsets corresponding to the plurality of subsets.

An embodiment of the disclosure, wherein a power control offset is used for obtaining a measurement value associated with a subset corresponding to the power control offset.

An embodiment of the disclosure, wherein the configuration includes information associated with a mode 1 or a mode 2,

An embodiment of the disclosure, wherein in case that the information is associated with the mode 1, the number of activated TXRUs is associated with a number of antenna ports being adjusted with a number of activated physical antenna elements per antenna port being maintained.

An embodiment of the disclosure, wherein in case that the information is associated with the mode 2, a number of activated physical antenna elements being adjusted with the number of antenna ports being maintained.

An embodiment of the disclosure, wherein the at least one measurement value is one of reference signal received power (RSRP), reference signal received quality (RSRQ), or a channel quality indicator (CQI).

An embodiment of the disclosure, a user equipment (UE) in a communication system is provided.

An embodiment of the disclosure, the UE may include a transceiver; and a processor coupled with the transceiver and configured to: receive, from a base station, a configuration of a channel state information (CSI) report, wherein the CSI report includes a plurality of subsets of CSI reference signal (CSI-RS) antenna ports; obtain at least one measurement value associated with at least one subset among the plurality of subsets; and transmit, to the base station, the CSI report including the at least one measurement value, wherein the at least one measurement value is associated with a number of activated transmitter receiver units (TXRUs) of the base station.

An embodiment of the disclosure, wherein a number of the at least one subset is identified based on a capability of the UE for a CSI processing unit (CPU) associated with the CSI report.

An embodiment of the disclosure, wherein the configuration includes a plurality of power control offsets corresponding to the plurality of subsets.

An embodiment of the disclosure, wherein a power control offset is used for obtaining a measurement value associated with a subset corresponding to the power control offset.

An embodiment of the disclosure, wherein the configuration includes information associated with a mode 1 or a mode 2.

An embodiment of the disclosure, wherein in case that the information is associated with the mode 1, the number of activated TXRUs is associated with a number of antenna ports being adjusted with a number of activated physical antenna elements per antenna port being maintained.

An embodiment of the disclosure, wherein in case that the information is associated with the mode 2, a number of activated physical antenna elements being adjusted with the number of antenna ports being maintained.

An embodiment of the disclosure, wherein the at least one measurement value is one of reference signal received power (RSRP), reference signal received quality (RSRQ), or a channel quality indicator (CQI).

According to an embodiment of the disclosure, it is possible to perform efficient CSI measurement and CSI report that solves the problem of excessive energy consumption of the base station and reduces the complexity of the terminal.

According to an embodiment of the disclosure, the base station can save energy by maintaining more components in an inactive state.

According to an embodiment of the disclosure, the terminal can improve overhead for CSI measurement and CSI report.

It will be appreciated by persons skilled in the art that the effects that can be achieved through the disclosure are not limited to what has been particularly described hereinabove and other advantages of the disclosure will be more clearly understood from the following detailed description.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a time-frequency domain, which is a radio resource domain, in a wireless communication system according to an embodiment of the present disclosure.

FIG. 2 illustrates a slot structure considered in a wireless communication system according to an embodiment of the present disclosure.

FIG. 3 illustrates an example of a time-domain mapping structure of a synchronization signal and a beam sweeping operation according to an embodiment of the present disclosure.

FIG. 4 illustrates a synchronization signal block considered in a wireless communication system according to an embodiment of the present disclosure.

FIG. 5 illustrates various transmission cases of a synchronization signal block in a frequency band of less than 6 GHz considered in a communication system according to an embodiment of the present disclosure.

FIG. 6 illustrates transmission cases of a synchronization signal block in a frequency band of 6 GHz or higher considered in a wireless communication system according to an embodiment of the present disclosure.

FIG. 7 illustrates transmission cases of a synchronization signal block according to a subcarrier spacing within 5 ms in a wireless communication system according to an embodiment of the present disclosure.

FIG. 8 illustrates a DMRS pattern (type 1 and type 2) used for communication between a base station and a UE in a wireless communication system according to an embodiment of the present disclosure.

FIG. 9 illustrates an example of channel estimation using a DMRS received in one PUSCH in a time domain of a wireless communication system according to an embodiment of the present disclosure.

FIG. 10 illustrates a method for reconfiguring SSB transmission through dynamic signaling of a wireless communication system according to an embodiment of the present disclosure.

FIG. 11 illustrates a method for reconfiguring BWP and BW through dynamic signaling of a wireless communication system according to an embodiment of the present disclosure.

FIG. 12 illustrates a method for reconfiguring DRX through dynamic signaling of a wireless communication system according to an embodiment of the present disclosure.

FIG. 13 illustrates a DTX method for energy saving of a base station according to an embodiment of the present disclosure.

FIG. 14 illustrates an operation of a base station according to a gNB wake-up signal according to an embodiment of the present disclosure.

FIG. 15 illustrates an antenna adaptation method of a base station for reducing energy consumption in a wireless communication system according to an embodiment of the present disclosure.

FIG. 16A illustrates an example of a method for receiving CSI feedback for each terminal to determine SD adaptation of a base station in a wireless communication system according to an embodiment of the disclosure.

FIG. 16B illustrates an example of a method for receiving CSI feedback for each UE to determine SD adaptation of a base station in a wireless communication system according to an embodiment of the disclosure.

FIG. 17A illustrates a CSI resource/resource set/report configuration method for a base station to determine SD adaptation for each terminal in a wireless communication system according to an embodiment of the disclosure.

FIG. 17B illustrates a CSI resource/resource set/report configuration method for a base station to determine SD adaptation for each terminal in a wireless communication system according to an embodiment of the disclosure.

FIG. 17C illustrates a CSI resource/resource set/report configuration method for a base station to determine SD adaptation for each terminal in a wireless communication system according to an embodiment of the disclosure.

FIG. 18 illustrates a selected CSI report method according to an SD adaptation type for energy saving of a base station in a wireless communication system according to an embodiment of the disclosure.

FIG. 19 illustrates a selected CSI report method according to an SD adaptation type for energy saving of a base station in a wireless communication system according to an embodiment of the disclosure.

FIG. 20 illustrates a flowchart for describing an operation of a terminal that applies an energy saving method of a wireless communication system according to an embodiment of the disclosure.

FIG. 21 illustrates a flowchart for describing an operation of a base station that applies an energy saving method of a wireless communication system according to an embodiment of the disclosure.

FIG. 22 illustrates a terminal according to an embodiment of the disclosure.

FIG. 23 illustrates a base station according to an embodiment of the disclosure.

### DETAILED DESCRIPTION

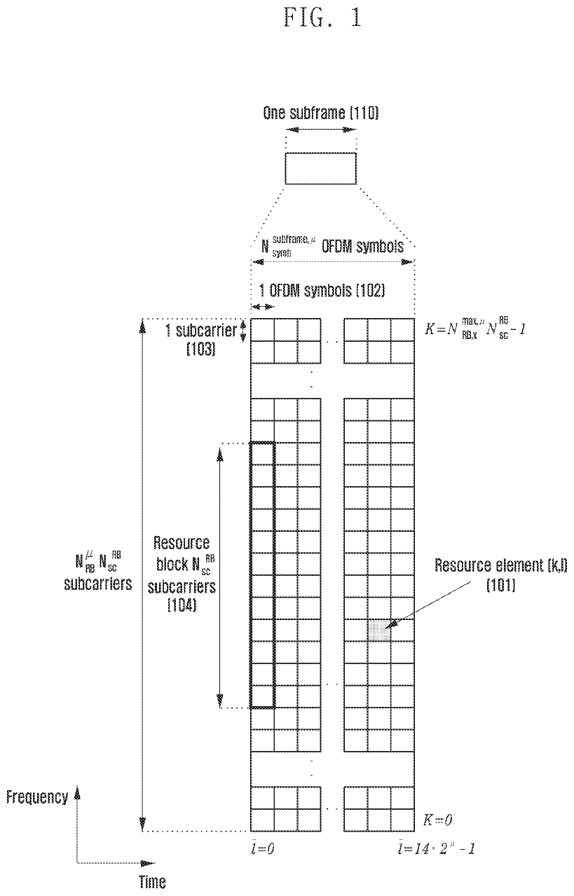

FIGS. 1 through 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings. In describing embodiments of the disclosure below, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Further, in describing the disclosure, a detailed description of known functions or constitutions incorporated herein will be omitted when it is determined that the description may make the subject matter of the disclosure unnecessarily unclear. The terms which will be described below are terms defined in consideration of the functions in the disclosure, and may be different according to users, intentions of operators, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a downlink(DL) refers to a radio transmission path via which a base station transmits a signal to a terminal, and an uplink(UL) refers to a radio transmission path via which a terminal transmits a signal to a base station. Further, in the following description, LTE or LTE-A systems may be described by way of example, but the embodiments of the disclosure may also be applied to other communication systems having similar technical backgrounds or channel types. Examples of such communication systems may include 5^{th} generation mobile communication technologies (5G, new radio, and NR) developed beyond LTE-A, and in the following description, the 5G may be the concept that covers the exiting LTE, LTE-A, and other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of blocks in the flowchart illustrations, can be implemented by computer program instructions. Since the computer program instructions may be equipped in a processor of a general purpose computer, special purpose computer or other programmable data processing apparatus, the instructions, which execute via the processor of the computer or other programmable data processing apparatus, create means for implementing the functions specified in the flowchart block(s). Since these computer program instructions may also be stored in a computer usable or computer-readable memory that can direct a computer or other programmable data processing apparatus to function in a particular manner, the instructions stored in the computer usable or computer-readable memory produce an article of manufacture including instruction means that implement the function specified in the flowchart block(s). The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block(s).

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, elements, such as software elements, object-oriented software elements, class elements, and task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit,” or divided into a larger number of elements, or a “unit.” Moreover, the elements and “units” or may be implemented to reproduce one or more CPUs within a device or a security multimedia card. Further, the “unit” in the embodiments may include one or more processors.

Hereinafter, embodiments of the disclosure are described in detail with reference to the accompanying drawings. The method and apparatus provided in the following embodiments of the disclosure are not limited to each embodiment, but may also be used as a combined embodiment of all or some of one or more embodiments provided in the disclosure. Therefore, embodiments of the disclosure may be modified in such a range as not to significantly depart from the scope of the disclosure under the determination by one of ordinary skill in the art and such modifications may be applicable.

Further, in describing the disclosure, a detailed description of known functions or constitutions incorporated herein will be omitted when it is determined that the description may make the subject matter of the disclosure unnecessarily unclear. The terms which will be described below are terms defined in consideration of the functions in the disclosure, and may be different according to users, intentions of operators, or customs. Therefore, the definitions of the terms should be made based on the contents throughout the specification.

Wireless communication systems evolve beyond voice-centered services to broadband wireless communication systems to provide high data rate and high-quality packet data services, such as 3GPP high speed packet access (HSPA), long term evolution (LTE) or evolved universal terrestrial radio access (E-UTRA), LTE-advanced (LTE-A), LTE-pro, 3GPP2 high rate packet data (HRPD), ultra mobile broadband (UMB), and IEEE 802.17e communication standards.

As a representative example of such broadband wireless communication system, the LTE system adopts orthogonal frequency division multiplexing (OFDM) for downlink (DL) and single carrier frequency division multiple access (SC-FDMA) for uplink (UL). The uplink may refer to a radio link in which the terminal (hereinafter, referred to as user equipment (UE)) (or mobile station (MS)) transmits data or control signals to the base station (eNode B (eNB) or base station (BS)), and the downlink refers to a radio link through which the base station transmits data or control signals to the terminal (UE). Also, the above-described multiple access scheme allocates and operates time-frequency resources carrying data or control information per user not to overlap, i.e., to maintain orthogonality, to thereby differentiate each user's data or control information.

Post-LTE communication systems, e.g., 5G communication systems, are required to simultaneously support various requirements to freely reflect various requirements from users and service providers. Services considered for 5G communication systems include enhanced mobile broadband (eMBB), massive machine type communication (MMTC), or ultra reliability low latency communication (URLLC).

eMBB aims to provide a further enhanced data rate as compared with the data rate supported by conventional LTE, LTE-A, or LTE-pro. For example, eMBB for 5G communication systems needs to provide a peak data rate of 20 Gbps on downlink and a peak data rate of 10 Gbps on uplink in terms of one base station. 5G communication systems also need to provide an increased user perceived data rate while simultaneously providing such peak data rate. To meet such requirements, various transmit/receive techniques, as well as multiple input multiple output (MIMO) transmission technology, may need to further be enhanced. Also, while the LTE system adopts a transmit bandwidth up to 20 MHz in the 2 GHz band to transmit signals, the 5G communication system employs a broader frequency greater than 20 MHz bandwidth in a frequency band ranging from 3 GHz to 6 GHz or more than 6 GHz to meet the data rate required for the 5G communication system.

At the same time, mMTC is also considered to support application services, such as internet of things (IoT) in the 5G communication system. To efficiently provide IoT, mMTC is required to support access of massive UES in the cell, enhance the coverage of the UE and the battery time, and reduce UE costs. IoT is attached to various sensors or devices to provide communication functionality, and thus, it needs to support a number of UES in the cell (e.g., 1,000,000 UES/km2). Further, since mMTC-supportive UES, by the nature of service, are highly likely to be located in shadow areas not covered by the cell, such as the underground of a building, it requires much broader coverage as compared with other services that the 5G communication system provides. mMTC-supportive UEs, due to the need for being low cost and difficulty in frequently exchanging batteries, are required to have a very long battery lifetime, e.g., 10 years to 16 years.

Lastly, URLLC is a mission-critical, cellular-based wireless communication service. For example, there may be considered a service for use in remote control for robots or machinery, industrial automation, unmanned aerial vehicles, remote health care, or emergency alert. Therefore, the communication that URLLC provides needs to provide very low-latency and very high-reliability. For example, URLLC-supportive services need to meet an air interface latency of less than 0.5 milliseconds simultaneously with a packet error rate of 10-5 or less. Thus, for URLLC-supportive services, the 5G communication system is required to provide a shorter transmit time interval (TTI) than those for other services while securing reliable communication links by allocating a broad resource in the frequency band.

The three services of the 5G communication system (hereinafter interchangeable with the 5G system), i.e., eMBB, URLLC, and mMTC, may be multiplexed and transmitted in one system. The services may adopt different transmit/receive schemes and transmit/receive parameters to meet their different requirements.

The frame structure of the 5G system is described below in more detail with reference to the drawings. Hereinafter, as wireless communication systems to which the disclosure is applied, 5G systems are described as an example for convenience of description. However, embodiments of the disclosure may also be applied to post-5G systems or other communication systems to which the disclosure is applicable in the same or similar manner.

FIG. 1 illustrates a basic structure of a time-frequency domain, which is a radio resource domain, in a wireless communication system according to an embodiment of the present disclosure.

In FIG. 1, a horizontal axis represents a time domain, and a vertical axis represents a frequency domain. A basic unit of a resource in the time and frequency domains is a resource element (RE) 101, which may be defined as one orthogonal frequency division multiplexing (OFDM) symbol (or discrete Fourier transform spread OFDM (DFT-s-OFDM) symbol) 102 on the time axis, and as one subcarrier 103 on the frequency axis. N_{SC}^{RB} (e.g., 12) consecutive Res, which represent the number of subcarriers per resource block (RB) in the frequency domain, may constitute one resource block (RB) 104. In addition, N_{symb}^{subframe,μ} consecutive OFDM symbols, which represent the number of symbols per subframe according to a configuration value u for a subcarrier spacing in the time domain, may constitute one subframe 110.

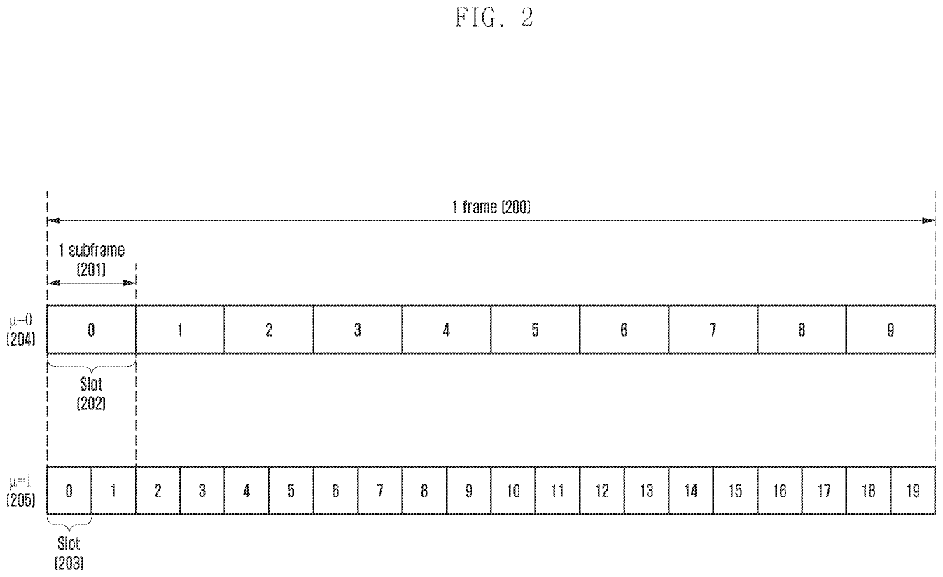

FIG. 2 illustrates a slot structure considered in a wireless communication system according to an embodiment of the present disclosure.

FIG. 2 illustrates an example of a slot structure including a frame 200, a subframe 201, and a slot 202 or 203. One frame 200 may be defined as 10 ms. One subframe 201 may be defined as 1 ms, and thus, one frame 200 may include a total of 10 subframes 201. One slot 202 or 203 may be defined as 14 OFDM symbols (that is, the number (N_{symb}^{slot}) of symbols per slot=14). One subframe 201 may be composed of one or multiple slots 202 or 203, and the number of slots 202 and 203 per subframe 201 may differ depending on μ (204 or 205), which is a configuration value for the subcarrier space (SCS).

A slot structure of μ=0 (204) and a slot structure of μ=1 (205) are shown as the configured subcarrier spacing values. In case of μ=0 (204), the subframe 201 may be constituted of one slot 202. In case of μ=1 (205), one subframe 201 may be constituted of two slots (e.g., including the slot 203). In other words, according to the configured subcarrier spacing value u, the number (Nₛₗₒₜ^{subframe,μ}) of slots per subframe may vary, and accordingly, the number (Nₛₗₒₜ^{frame,μ}) of slots per frame may differ. For example, according to each subcarrier spacing configuration u, Nₛₗₒₜ^{subframe,μ} and Nₛₗₒₜ^{frame,μ} may be defined in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |
| 6 | 14 | 640 | 64 |

In the 5G wireless communication system, a synchronization signal block (which may be interchangeably used with SS block (SSB), or SS/PBCH block) may be transmitted for initial access of the UE. The synchronization signal block may include a primary synchronization signal (PSS), a secondary synchronization signal (SSS), and a physical broadcast channel (PBCH).

In the initial access phase in which the UE accesses the system, the UE may obtain downlink time and frequency domain synchronization from a synchronization signal through a cell search and obtain the cell ID. The synchronization signal may include a PSS and an SSS. Also, the UE may receive the PBCH, transmitting a master information block (MIB), from the base station, and obtain system information related to transmission and reception, such as system bandwidth or related control information, and basic parameter values. Based on the information, the UE may perform decoding on a physical downlink control channel (PDCCH) and a physical downlink shared channel (PDSCH), and obtain the system information block (SIB). Thereafter, the UE may exchange identification-related information for the base station and UE through a random access phase and undergoes registration and authentication phases to thus initially access the network. Further, the UE may receive system information (system information block (SIB)) transmitted by the base station to obtain cell-common transmission/reception-related control information. The cell-common transmission/reception-related control information may include random access-related control information, paging-related control information, and common control information about various physical channels.

A synchronization signal is a signal that is a reference signal for cell search, and subcarrier spacing may be applied for each frequency band to suit the channel environment, such as phase noise. In the case of a data channel or control channel, different subcarrier spacings may be applied depending on service types to support various services as described above.

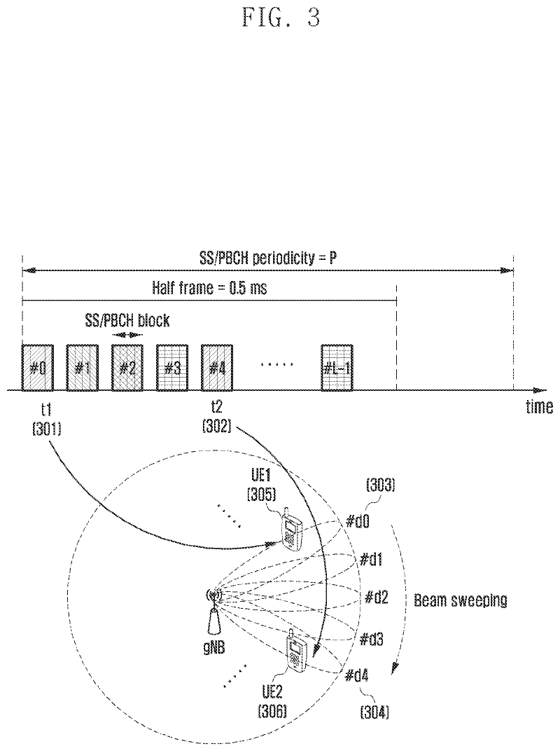

FIG. 3 illustrates an example of a time-domain mapping structure of a synchronization signal and a beam sweeping operation according to an embodiment of the present disclosure.

For purposes of illustration, the following components may be defined.

Primary synchronization signal (PSS): It serves as a reference signal for DL time/frequency synchronization and provides part of the information for cell ID.

Secondary synchronization signal (SSS): It serves as a reference for DL time/frequency synchronization and provides remaining partial cell ID information. Additionally, it may serve as a reference signal for demodulation of PBCH.

Physical broadcast channel (PBCH): It provides a master information block (MIB), which is essential system information required data channel and control channel transmission/reception by the UE. The essential system information may include search space-related control information indicating radio resource mapping information about a control channel, scheduling control information for a separate data channel for transmitting system information, and information, such as system frame number (SFN), which is the frame unit index serving as a timing reference.

Synchronization signal/PBCH block or SSB (SS/PBCH block): The SS/PBCH block is constituted of N OFDM symbols and is composed of a combination of the PSS, SSS, PBCH, and the like. In the case of a system to which beam sweeping technology is applied, the SS/PBCH block is the minimum unit to which beam sweeping is applied. In the 5G system, N=4. The base station may transmit up to L SS/PBCH blocks. The L SS/PBCH blocks are mapped within a half frame (0.5 ms). The L SS/PBCH blocks are periodically repeated every predetermined period P. The base station may inform the UE of the period P through signaling. In case where there is no separate signaling for the period P, the UE applies a previously agreed default value.

With reference to FIG. 3, FIG. 3 illustrates an example in which beam sweeping is applied on the unit of SS/PBCH block over time. In an example of FIG. 3, UE1 305 receives the SS/PBCH block using the beam radiated in direction #d0 303 by the beamforming applied to SS/PBCH block #0 at time t1 301. Also, UE2 306 receives the SS/PBCH block using the beam radiated in direction #d4 304 by the beamforming applied to SS/PBCH block #4, at time t2 302. The UE may obtain an optimal synchronization signal through the beam radiated from the base station in the direction where the UE is positioned. For example, it may be difficult for UE1 305 to obtain time/frequency synchronization and essential system information from the SS/PBCH block through the beam radiated in direction #d4 away from the position of UE1.

In addition to the initial access procedure, the UE may also receive the SS/PBCH block to determine whether the radio link quality of a current cell is maintained at a certain level or higher. Further, in a handover procedure in which the UE moves access from a current cell to a neighboring cell, the UE may determine the radio link quality of the neighboring cell and receive the SS/PBCH block of the neighboring cell to obtain time/frequency synchronization of the neighboring cell.

A cell initial access procedure of a 5G wireless communication system is described below in more detail with reference to the drawings.

The synchronization signal is a signal serving as a reference for cell search and may be transmitted, with a subcarrier spacing appropriate for the channel environment (e.g., including phase noise) for each frequency band applied thereto. The 5G base station may transmit a plurality of synchronization signal blocks according to the number of analog beams to be operated. For example, a PSS and SSS may be mapped over 12 RBs and transmitted, and a PBCH may be mapped over 24 RBs and transmitted. Described below is a structure in which a synchronization signal and PBCH are transmitted in a 5G communication system.

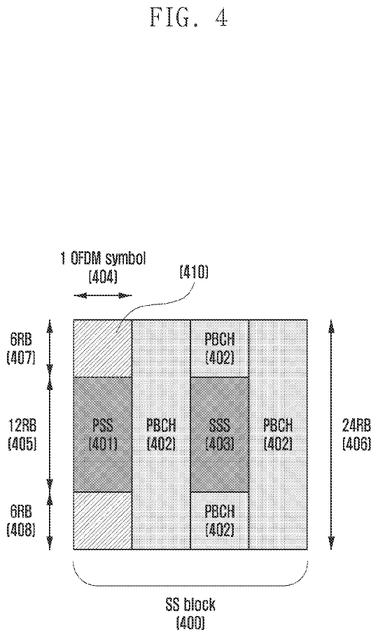

FIG. 4 illustrates a synchronization signal block considered in a wireless communication system to according to an embodiment of the present disclosure.

According to FIG. 4, a synchronization signal block (SS block) 400 may include a PSS 401, an SSS 403, and broadcast channels (PBCH) 402.

The synchronization signal block 400 may be mapped to four OFDM symbols 404 on the time axis. The PSS 401 and the SSS 403 may be transmitted in 12 RBs 405 on the frequency axis and in first and third OFDM symbols on the time axis, respectively. In the 5G system, e.g., a total of 1008 different cell IDs may be defined. The PSS 401 may have three different values according to the physical cell ID (PCI) of the cell, and the SSS 403 may have 336 different values. The UE may obtain one of (336×3=)1,008 cell IDs, as a combination, by detection on the PSS 401 and SSS 403. This may be represented as Equation 1.

$${N}_{ID}^{cell} = 3 {N}_{ID}^{( 1 )} + {N}_{ID}^{( 2 )} \qquad [ Equation 1 ]$$

where N_{ID}⁽¹⁾ may be estimated from the SSS 403 and have a value between 0 and 335. N_{ID}⁽²⁾ may be estimated from the PSS 401 and have a value between 0 and 2. The UE may estimate N_{ID}^{(cell)} which is the cell ID, by a combination of N_{ID}⁽¹⁾ and N_{ID}⁽²⁾.

The PBCH 402 may be transmitted in the resource including 24 RBs 406 on the frequency axis and 6 RBs 407 and 408 on both sides of each of the second and fourth OFDM symbols of the SS block, except for the intermediate 12 RBs 405 where the SSS 403 is transmitted, on the time axis. The PBCH 402 may include a PBCH payload and a PBCH demodulation reference signal (DMRS). In the PBCH payload, various system information called MIB may be transmitted. For example, the MIB may include information as shown in Table 2 below.

TABLE 2

```
MIB ::= SEQUENCE {
  systemFrameNumber BIT STRING (SIZE (6)),
  subCarrierSpacingCommon ENUMERATED {scs15or60, scs30or120},
  ssb-SubcarrierOffset INTEGER (0..15),
  dmrs-TypeA-Position ENUMERATED {pos2, pos3},
  pdcch-ConfigSIB1 PDCCH-ConfigSIB1,
  cellBarred ENUMERATED {barred, notBarred},
  intraFreqReselection ENUMERATED {allowed, notAllowed},
  spare BIT STRING (SIZE (1))
}
```

Synchronization signal block information: The offset in the frequency domain of the synchronization signal block may be indicated through the four-bit ssb-SubcarrierOffset in the MIB. The index of the synchronization signal block including the PBCH may be indirectly obtained through decoding of the PBCH DMRS and PBCH. In an embodiment, in a frequency band below 6 GHZ, 3 bits obtained through decoding of the PBCH DMRS indicate the synchronization signal block index and, in a frequency band of 6 GHz or higher, 6 bits in total, including 3 bits obtained through decoding of the PBCH DMRS and 3 bits included in the PBCH payload and obtained by PBCH decoding may indicate the synchronization signal block index including the PBCH.

Physical downlink control channel (PDCCH) configuration information: the subcarrier spacing of the common downlink control channel may be indicated through 1 bit (subCarrierSpacingCommon) in the MIB, and the time-frequency resource configuration information of the search space (SS) and control resource set (CORESET) may be indicated through 8 bits (pdcch-ConfigSIB1).

System frame number (SFN): 6 bits (systemFrameNumber) in the MIB may be used to indicate a part of the SFN. The 4 least significant bits (LSBs) of the SFN are included in the PBCH payload, and the UE may indirectly obtain the LSBs through PBCH decoding.

Timing information in the radio frame: 1 bit (half frame) obtained through PBCH decoding and included in the PBCH payload and synchronization signal block index described above. The UE may indirectly identify whether the synchronization signal block is transmitted in the first or second half frame of the radio frame.

Since the transmission bandwidth (12 RBs 405) of the PSS 401 and SSS 403 and the transmission bandwidth (24 RBs 406) of the PBCH 402 are different from each other, the first OFDM symbol where the PSS 401 is transmitted in the PBCH (402) transmission bandwidth has 6 RBs 407 and 408 on both sides except the intermediate 12 RBs where the PSS 401 is transmitted, and the region may be used to transmit other signals or may be empty.

The synchronization signal blocks may be transmitted using the same analog beam. For example, the PSS 401, SSS 403, and PBCH 402 may all be transmitted through the same beam. Since the analog beam, by its nature, cannot be applied differently on the frequency axis, the same analog beam may be applied to all the RBs on the frequency axis within a specific OFDM symbol to which a specific analog beam is applied. For example, all of the four OFDM symbols in which the PSS 401, SSS 403, and PBCH 402 are transmitted may be transmitted using the same analog beam.

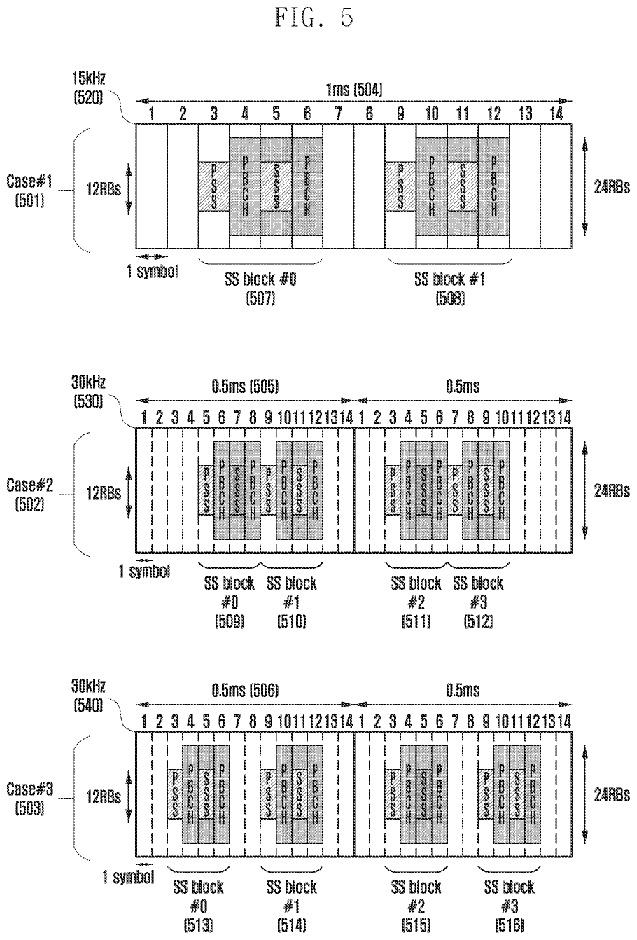

FIG. 5 illustrates transmission cases of a synchronization signal block in a frequency band of less than 6 GHz considered in a communication system according to an embodiment of the present disclosure.

With reference to FIG. 5, in the 5G communication system, in a frequency band of 6 GHz or less (or FR1 (frequency range 1), e.g., 410 MHz to 7125 MHZ), a subcarrier spacing (SCS) 520 of 15 kHz and a subcarrier spacing of 30 kHz (530 or 440) may be used for synchronization signal block transmission. In the 15 kHz subcarrier spacing 520, there is one transmission case (e.g., Case #1 (501)) for the synchronization signal block and, in the 30 kHz subcarrier spacing 530 or 540, there may be two transmission cases for the synchronization signal block (e.g., Case #2 (402) and Case #3 503).

In FIG. 5, in Case #1 (501) of the 15 kHz subcarrier spacing (520), up to two synchronization signal blocks may be transmitted within 1 ms (504) (or, in case where 1 slot includes 14 OFDM symbols, it corresponds to a length of 1 slot). In the example of FIG. 4, synchronization signal block #0 507 and synchronization signal block #1 508 are shown. For example, the synchronization signal block #0 507 may be mapped to four consecutive symbols from the 3^{rd} OFDM symbol, and the synchronization signal block #1 508 may be mapped to four consecutive symbols from the 9^{th} OFDM symbol.

Different analog beams may be applied to the synchronization signal block #0 507 and synchronization signal block #1 508. Also, the same beam may be applied to all of the 3^{rd} to 6^{th} OFDM symbols to which synchronization signal block #0 507 is mapped, and the same beam may be applied to all of the 9^{th} to 12^{th} OFDM symbols to which synchronization signal block #1 508 is mapped. In the 7^{th}, 8^{th}, 13^{th}, and 14^{th} OFDM symbols to which no synchronization signal block is mapped, an analog beam to be used may be freely determined under the determination of the base station.

In FIG. 5, in Case #2 (502) of the 30 kHz subcarrier spacing (530), up to two synchronization signal blocks may be transmitted within 0.5 ms (505) (or, in case where 1 slot includes 14 OFDM symbols, it corresponds to a length of 1 slot), and accordingly, up to four synchronization signal blocks may be transmitted within 1 ms (or, in case where 1 slot includes 14 OFDM symbols, it corresponds to a length of 2 slots). FIG. 4 illustrates an example in which synchronization signal block #0 509, synchronization signal block #1 510, synchronization signal block #2 511, and synchronization signal block #3 512 are transmitted within 1 ms (i.e., two slots). Synchronization signal block #0 509 and synchronization signal block #1 510 may be mapped from the 5^{th} OFDM symbol and 9^{th} OFDM symbol, respectively, of the first slot. Synchronization signal block #2 511 and synchronization signal block #3 512 may be mapped from the 3^{rd} OFDM symbol and 7^{th} OFDM symbol, respectively, of the second slot.

Different analog beams may be applied to synchronization signal block #0 509, synchronization signal block #1 510, synchronization signal block #2 511, and synchronization signal block #3 512. Also, the same analog beam may be applied to the 5^{th} to 8^{th} OFDM symbols of the first slot in which synchronization signal block #0 509 is transmitted, the 9^{th} to 12^{th} OFDM symbols of the first slot in which synchronization signal block #1 510 is transmitted, the 3^{rd} to 6^{th} symbols of the second slot in which synchronization signal block #2 511 is transmitted, and the 7^{th} to 10^{th} symbols of the second slot in which synchronization signal block #3 512 is transmitted. In the OFDM symbols to which no synchronization signal block is mapped, an analog beam to be used may be freely determined under the determination of the base station.

In FIG. 5, in Case #3 (503) of the 30 kHz subcarrier spacing (540), up to two synchronization signal blocks may be transmitted within 0.5 ms (506) (or, in case where 1 slot includes 14 OFDM symbols, it corresponds to a length of 1 slot), and accordingly, up to four synchronization signal blocks may be transmitted within 1 ms (or, in case where 1 slot includes 14 OFDM symbols, it corresponds to a length of 2 slots). FIG. 4 illustrates an example in which synchronization signal block #0 513, synchronization signal block #1 514, synchronization signal block #2 515, and synchronization signal block #3 516 are transmitted within 1 ms (i.e., two slots). Synchronization signal block #0 513 and synchronization signal block #1 514 may be mapped from the 3^{rd} OFDM symbol and 9^{th} OFDM symbol, respectively, of the first slot, and synchronization signal block #2 515 and synchronization signal block #3 516 may be mapped from the 3^{rd} OFDM symbol and 9^{th} OFDM symbol, respectively, of the second slot.

Different analog beams may be used for synchronization signal block #0 513, synchronization signal block #1 514, synchronization signal block #2 515, and synchronization signal block #3 516, respectively. As described above in connection with examples, the same analog beam may be used in all four OFDM symbols in which each synchronization signal block is transmitted, and which beam is used in OFDM symbols to which no synchronization signal block is mapped may be freely determined by the base station.

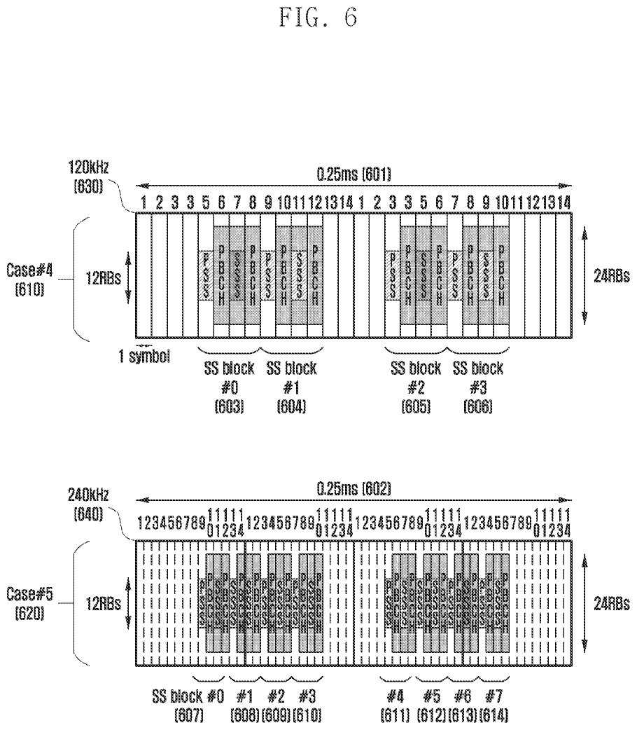

FIG. 6 illustrates transmission cases of a synchronization signal block in a frequency band of 6 GHz or higher considered in a wireless communication system according to an embodiment of the present disclosure.

In the 5G communication system, in a frequency band of 6 GHz or higher (or FR2, e.g., 24250 MHz to 52600 MHZ), the subcarrier spacing of 120 kHz (630) as in the example of Case #4 (610) and the subcarrier spacing of 240 kHz (640) as in the example of Case #5 (620) may be used for synchronization signal block transmission.

In Case #4 (610) of the 120 kHz subcarrier spacing (630), up to four synchronization signal blocks may be transmitted within 0.25 ms (601) (or, in case where 1 slot includes 14 OFDM symbols, it corresponds to a length of 2 slots). FIG. 6 illustrates an example in which synchronization signal block #0 603, synchronization signal block #1 604, synchronization signal block #2 605, and synchronization signal block #3 606 are transmitted within 0.25 ms (i.e., two slots). Synchronization signal block #0 603 and synchronization signal block #1 604 may be mapped to four consecutive symbols from the 5^{th} OFDM symbol and to four consecutive symbols from the 9^{th} OFDM symbol, respectively, of the first slot, and synchronization signal block #2 605 and synchronization signal block #3 606 may be mapped to four consecutive symbols from the 3^{rd} OFDM symbol and to four consecutive symbols from the 7^{th} OFDM symbol, respectively, of the second slot.

As described above in connection with the above embodiments, different analog beams may be used for synchronization signal block #0 603, synchronization signal block #1 604, synchronization signal block #2 605, and synchronization signal block #3 606. Also, the same analog beam may be used in all four OFDM symbols in which each synchronization signal block is transmitted, and which beam is used in OFDM symbols to which no synchronization signal block is mapped may be freely determined by the base station.

In Case #5 (620) of the 240 kHz subcarrier spacing (640), up to eight synchronization signal blocks may be transmitted within 0.25 ms (602) (or, in case where 1 slot includes 14 OFDM symbols, it corresponds to a length of 4 slots). FIG. 6 illustrates an example in which synchronization signal block #0 607, synchronization signal block #1 608, synchronization signal block #2 609, synchronization signal block #3 610, synchronization signal block #4 611, synchronization signal block #5 612, synchronization signal block #6 613, and synchronization signal block #7 614 are transmitted within 0.25 ms (i.e., 4 slots).

Synchronization signal block #0 607 and synchronization signal block #1 608 may be mapped to four consecutive symbols from the 9^{th} OFDM symbol and to four consecutive symbols from the 13^{th} OFDM symbol, respectively, of the first slot, synchronization signal block #2 609 and synchronization signal block #3 610 may be mapped to four consecutive symbols from the 3^{rd} OFDM symbol and to four consecutive symbols from the 7^{th} OFDM symbol, respectively, of the second slot, synchronization signal block #4 611, synchronization signal block #5 612, and synchronization signal block #6 613 may be mapped to four consecutive symbols from the 5^{th} OFDM symbol, to four consecutive symbols from the 9^{th} OFDM symbols, and to four consecutive symbols from the 13^{th} OFDM symbol, respectively, of the third slot, and synchronization signal block #7 614 may be mapped to four consecutive symbols from the 3^{rd} OFDM symbol of the fourth slot.

As described in connection with the above embodiment, synchronization signal block #0 607, synchronization signal block #1 608, synchronization signal block #2 609, synchronization signal block #3 610, synchronization signal block #4 611, synchronization signal block #5 612, synchronization signal block #6 613, and synchronization signal block #7 614 may use different analog beams. Also, the same analog beam may be used in all four OFDM symbols in which each synchronization signal block is transmitted, and which beam is used in OFDM symbols to which no synchronization signal block is mapped may be freely determined by the base station.

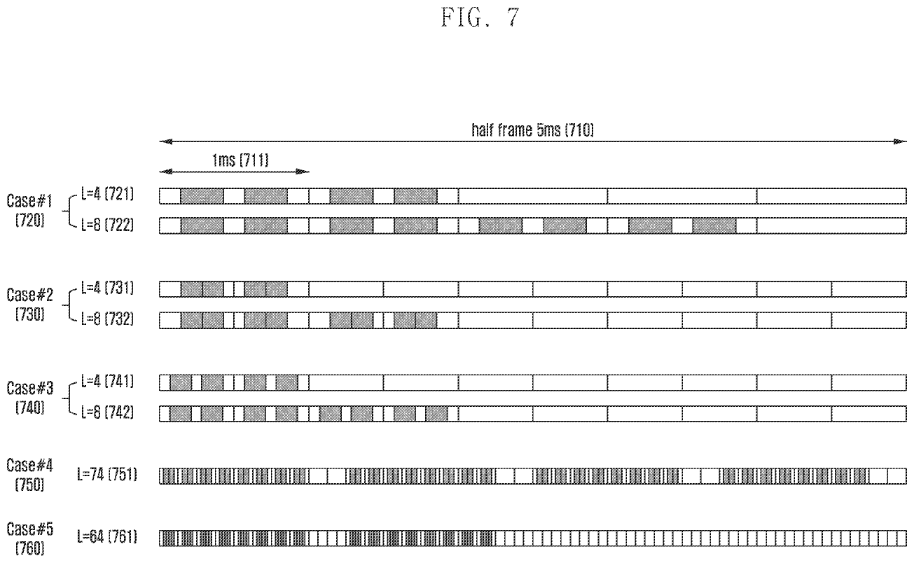

FIG. 7 illustrates transmission cases of a synchronization signal block according to a subcarrier spacing within 5 ms in a wireless communication system according to an embodiment of the present disclosure.

With reference to FIG. 7, in the 5G communication system, synchronization signal blocks may be transmitted periodically, e.g., every time interval (710) of 5 ms (corresponding to five subframes or a half frame).

In a frequency band of 3 GHz or less, up to four synchronization signal blocks may be transmitted within 5 ms (710). Up to 8 synchronization signal blocks may be transmitted in a frequency band exceeding 3 GHZ and 6 GHz or less. In a frequency band exceeding 6 GHZ, up to 64 synchronization signal blocks may be transmitted. As described above, the subcarrier spacings of 15 kHz and 30 kHz may be used at frequency of 6 GHz or less.

In the example of FIG. 7, in Case #1 (720) of the 15 kHz subcarrier spacing including one slot of FIG. 7, in a frequency band of 3 GHz or less, synchronization signal blocks may be mapped to the first slot and the second slot so that up to four synchronization signal blocks 721 may be transmitted, and in a frequency band exceeding 3 GHZ and a frequency band of 6 GHz or less, synchronization signal blocks may be mapped to the first, second, third, and fourth slots, so that up to eight synchronization signal blocks 722 may be transmitted. In Case #2 (730) or Case #3 (740) of the 30 kHz subcarrier spacing including two slots in FIG. 7, in a frequency band of 3 GHz or less, synchronization signal blocks may be mapped starting from the first slot, so that up to four synchronization signal blocks 731 and 741 may be transmitted, and in a frequency band exceeding 3 GHz and a frequency band of 6 GHz or less, synchronization signal blocks may be mapped starting from the first and third slots, so that up to eight synchronization signal blocks 732 and 742 may be transmitted.

The subcarrier spacings of 120 kHz and 240 kHz may be used at frequencies exceeding 6 GHz. In the example of FIG. 7, in Case #4 (750) of the 120 kHz subcarrier spacing including two slots of FIG. 7, in a frequency band exceeding 6 GHz, synchronization signal blocks may be mapped starting from 1^{st}, 3^{rd}, 5^{th}, 7^{th}, 11^{th}, 13^{th}, 15^{th}, 17^{th}, 21^{st}, 23^{rd}, 25^{th}, 27^{th}, 31^{st}, 33^{rd}, 35^{th}, and 37^{th} slots so that up to 74 synchronization signal blocks 751 may be transmitted. In the example of FIG. 7, in Case #5 (760) of the 240 kHz subcarrier spacing including 4 slots of FIG. 7, in a frequency band exceeding 6 GHz, synchronization signal blocks may be mapped starting from the 1^{st}, 5^{th}, 9^{th}, 13^{rd}, 21^{st}, 25^{th}, 29^{th}, and 33^{rd} slots so that up to 64 synchronization signal blocks 761 may be transmitted.

The UE may obtain the SIB after decoding the PDCCH and PDSCH based on the system information included in the received MIB. The SIB may include at least one of uplink cell bandwidth-related information, random access parameters, paging parameters, and parameters related to uplink power control.

In general, the UE may form a radio link with the network through a random access procedure based on the system information and synchronization with the network obtained in the cell search process of the cell. For random access, a contention-based or contention-free scheme may be used. In case where the UE performs cell selection and reselection in the phase of initial access to the cell, a contention-based random access scheme may be used for the purpose of, e.g., switching from an RRC_IDLE (RRC idle) state to an RRC_CONNECTED (RRC connected) state. Contention-free random access may be used in case where downlink data arrives, in the case of handover, or for re-establishing uplink synchronization for location measurement. Table 3 below illustrates conditions (events) under which a random access procedure is triggered in the 5G system.

```
TABLE 3
  - Initial access from RRC_IDLE;
  - RRC Connection Re-establishment procedure;
  - DL or UL data arrival during RRC_CONNECTED when UL
synchronisation status is “non-synchronised”;
  - UL data arrival during RRC_CONNECTED when there are no
PUCCH resources for SR available;
  - SR failure;
  - Request by RRC upon synchronous reconfiguration (e.g., handover);
  - RRC Connection Resume procedure from RRC_INACTIVE;
  - To establish time alignment for a secondary TAG;
  - Request for Other SI;
  - Beam failure recovery;
  - Consistent UL LBT failure on SpCell.
```

Hereinafter, a method for configuring a measurement time for radio resource management (RRM) based on a synchronization signal block (SS block or SSB) of a 5G wireless communication system is described.

The UE receives MeasObjectNR of MeasObjectToAddModlist as configurations for SSB-based intra/inter-frequency measurements and channel state information (CSI)-reference signal (RS)-based intra/inter-frequency measurements through higher layer signaling. For example, MeasObjectNR may be constituted as shown in Table 4 below.

```
TABLE 4
    MeasObjectNR ::= SEQUENCE {
      ssbFrequency ARFCN-ValueNR OPTIONAL, -- Cond
SSBorAssociatedSSB
      ssbSubcarrierSpacing SubcarrierSpacing OPTIONAL, -- Cond
SSBorAssociatedSSB
      smtc1 SSB-MTC OPTIONAL, -- Cond SSBorAssociatedSSB
      smtc2 SSB-MTC2 OPTIONAL, -- Cond IntraFreqConnected
      refFreqCSI-RS ARFCN-ValueNR OPTIONAL, -- Cond CSI-
RS
      referenceSignalConfig ReferenceSignalConfig,
      absThreshSS-BlocksConsolidation ThresholdNR OPTIONAL, --
Need R
      absThreshCSI-RS-Consolidation ThresholdNR OPTIONAL, --
Need R
      nrofSS-BlocksToAverage INTEGER (2..maxNrofSS-BlocksToAverage)
OPTIONAL, -- Need R
      nrofCSI-RS-ResourcesToAverage INTEGER (2..maxNrofCSI-RS-
ResourcesToAverage) OPTIONAL, -- Need R
      quantityConfigIndex INTEGER (1..maxNrofQuantityConfig),
      offsetMO Q-OffsetRangeList,
      cellsToRemoveList PCI-List OPTIONAL, -- Need N
      cellsToAddModList CellsToAddModList OPTIONAL, -- Need
N
      blackCellsToRemoveList PCI-RangeIndexList OPTIONAL, -- Need
N
      blackCellsToAddModList SEQUENCE (SIZE (1..maxNrofPCI-Ranges)) OF PCI-
RangeElement OPTIONAL, -- Need N
      whiteCellsToRemoveList PCI-RangeIndexList OPTIONAL, -- Need
N
      whiteCellsToAddModList SEQUENCE (SIZE (1..maxNrofPCI-Ranges)) OF PCI-
RangeElement OPTIONAL, -- Need N
      ...,
      [[
      freqBandIndicatorNR FreqBandIndicatorNR OPTIONAL, -- Need
R
      measCycleSCell ENUMERATED {sf160, sf256, sf320, sf512, sf640, sf1024,
sf1280} OPTIONAL -- Need R
      ]],
      ]]
      smtc3list-r16 SSB-MTC3List-r16 OPTIONAL, -- Need R
      rmtc-Config-r16 SetupRelease {RMTC-Config-r16} OPTIONAL, --
Need M
      t312-r16 SetupRelease { T312-r16 } OPTIONAL -- Need M
      ]]
    -
```

ssbFrequency: It may configure the frequency of the synchronization signal related to MeasObjectNR.
ssbSubcarrierSpacing: It configures the subcarrier spacing of SSB. FR1 may only apply 15 kHz or 30 kHz, and FR2 may only apply 120 kHz or 240 kHz.
smtc1: It indicates the SS/PBCH block measurement timing configuration, and may configure the primary measurement timing configuration and configure the timing offset and duration for SSB.
smtc2: It may configure the secondary measurement timing configuration for SSB related to MeasObjectNR with the PCI listed in the pci-List.

This may also be configured through other higher layer signaling. For example, the SMTC may be configured in the UE through reconfiguration WithSync for NR PSCell change or Nr PCell change or SIB2 for intra-frequency, inter-frequency, and inter-RAT cell reselection. Further, the SMTC may be configured in the UE through SCellConfig for adding an Nr SCell.

The UE may configure the first SS/PBCH block measurement timing configuration (SMTC) according to the periodicityAndOffset (providing periodicity and offset) through smtc1 configured through higher layer signaling for SSB measurement. In an embodiment, the first subframe of each SMTC occasion may start in the subframe of SpCell and the system frame number (SFN) meeting the conditions of Table 5.

TABLE 5

```
SFN mod T = (FLOOR (Offset/10));
if the Periodicity is larger than sf5:
  subframe = Offset mod 10;
else:
  subframe = Offset or (Offset +5);
with T = CEIL(Periodicity/10).
```

If smtc2 is configured, the UE may configure an additional SMTC according to the offset and duration of smtc1 and the periodicity of smtc2 configured, for the cells indicated by the pci-List value of smtc2 in the same MeasObjectNR. In addition, the UE may have the smtc configured thereto through the smtc3list for smtc2-LP (with long periodicity) and integrated access and backhaul-mobile termination (IAB-MT) for the same frequency (e.g., frequency for intra frequency cell reselection) or other frequencies (e.g., frequencies for inter frequency cell reselection) and may measure the SSB. In an embodiment, the UE may not consider the SSB transmitted in a subframe other than the SMTC occasion for SSB-based RRM measurement at the configured ssbFrequency.

The base station may use various multi-transmit/receive point (TRP) operation methods depending on the serving cell configuration and physical cell identifier (PCI) configuration. Among them, there may be two methods for operating the two TRPs in case where two TRPs positioned in a distance physically away from each other have different PCIs.

### [Operation Method 1]

The two TRPs having different PCIs may be operated as two serving cell configurations.

The base station may include the channels and signals transmitted in different TRPs through operation method 1 in different serving cell configurations and configure them. In other words, each TRP may have an independent serving cell, and frequency bandwidth value FrequencyInfoDLs indicated by the DownlinkConfigCommon in each serving cell configurations may indicate bands that at least partially overlap each other. Since the several TRPs operate based on multiple ServCellIndexes (e.g., ServCellIndex #1 and ServCellIndex #2), each TRP may use a separate PCI. In other words, the base station may assign one PCI to each ServCellIndex.

In this case, when several SSBs are transmitted in TRP 1 and TRP 2, the SSBs may have different PCIs (e.g., PCI #1 and PCI #2), and the base station may properly select the ServCellIndex value indicated by the cell parameter in QCL-Info, map the PCI suitable for each TRP, and designate the SSB transmitted in either TRP 1 or TRP 2 as the source reference RS of the QCL configuration information. However, this configuration is to apply one serving cell configuration available for carrier aggregation (CA) to multiple TRPs and may thus have problems of restricting the degree of freedom of the CA configuration or increasing signaling loads.

### [Operation Method 2]

The two TRPs having different PCIs may be operated as one serving cell configuration.

The base station may configure the channels and signals transmitted in different TRPs through operation method 2 through one serving cell configuration. Since the UE operates based on one ServCellindex (e.g., ServCellindex #1), it is impossible to recognize the PCI assigned to the second TRP (e.g., PCI #2). Operation method 1 may have a degree of freedom of CA configuration as compared with operation method 1 described above. However, when several SSBs are transmitted in TRP 1 and TRP 2, the SSBs may have different PCIs (e.g., PCI #1 and PCI #2), and the base station may not be able to map the PCI (e.g., PCI #2) of the second TRP through the ServCellIndex indicated by the cell parameter in QCL-Info. The base station may only designate the SSB transmitted in TRP 1 with the source reference RS of the QCL configuration information and may not be able to designate the SSB transmitted in TRP 2.

As described above, operation method 1 may perform multi-TRP operation for two TRPs having different PCIs through an additional serving cell configuration without support of additional specifications, but operation method 2 may operate based on the following additional UE capability report and base station configuration information.

### Regarding UE Capability Report for Operation Method-2

The UE may report, to the base station, through UE capability, that it is possible to configure the PCI of the serving cell and another additional PCI through higher layer signaling from the base station. The corresponding UE capability may include X1 and X2 which are numbers independent of each other, or X1 and X2 may be reported as independent UE capabilities.
X1 means the maximum number of additional PCIs configurable to the UE. The PCI may be different from the PCI of the serving cell and, in this case, may mean the case where the time domain position and periodicity of the SSB corresponding to the additional PCI are the same as those of the SSB of the serving cell.
X2 means the maximum number of additional PCIs configurable to the UE. In this case, the PCI may be different from the PCI of the serving cell and, in this case, may mean the case where the time domain position and periodicity of the SSB corresponding to the additional PCI are different from those of the SSB corresponding to the PCI reported as X1.
By definition, the PCIs corresponding to the values reported as X1 and X2 may not be configured simultaneously with each other.
The values reported as X1 and X2 reported through the UE capability report may each have a value of one integer from 0 to 7.
The values reported as X1 and X2 may be reported as different values in FR1 and FR2.

### Regarding Higher Layer Signaling Configuration for Operation Method 2

The UE may have SSB-MTCAdditionalPCI-r17, which is higher layer signaling, configured thereto by the base station based on the above-described UE capability report. The corresponding higher layer signaling may include a plurality of additional PCIs having different values from, at least, the serving cell, the SSB transmission power corresponding to each additional PCI, and ssb-PositionInBurst corresponding to each additional PCI. The maximum number of additional PCIs configurable may be seven.
The UE may be assumed to have the same center frequency, subcarrier spacing, and subframe number offset as those of the SSB of the serving cell as an assumption for the SSB corresponding to an additional PCI having a different value from that of the serving cell.
The UE may assume that the reference RS (e.g., SSB or CSI-RS) corresponding to the PCI of the serving cell is connected to the always-active TCI state. When there are one or a plurality of additionally configured PCIs having a value different from the serving cell, only one PCI among the corresponding PCIs may be assumed to be connected to the activated TCI state.
In case where the UE has two different corsesetPoolIndexes configured thereto, the reference RS corresponding to the serving cell PCI is connected to one or a plurality of activated TCI states, and the reference RS corresponding to the additionally configured PCI having a different value from that of the serving cell is connected to one or a plurality of activated TCI states, the UE may expect that the activated TCI state(s) connected with the serving cell PCI are connected to one of the two coresetPoolIndexes, and the activated TCI state(s) connected with the additionally configured PCI having a different value from that of the serving cell are connected to the remaining one coresetPoolIndex.

The UE capability reporting and base station higher layer signaling for operation method 2 described above may configure an additional PCI having a value different from that of the PCI of the serving cell. In case where the above configuration is absent, the SSB corresponding to the additional PCI having a different value from the PCI of the serving cell which may not be designated by the source reference RS may be used for the purpose of designating the source reference RS of the QCL configuration information. Further, unlike the SSB configurable for use for the purpose of RRM, mobility, or handover, such as the configuration information about the SSB configurable in smtc1 and smtc2 which is the higher layer signaling, it may be used to serve as a QCL source RS for supporting multi-TRP operations having different PCIs.

Next, a demodulation reference signal (DMRS) which is a reference signal in the 5G system is specifically described.

The DMRS may be composed of several DMRS ports. The respective ports maintain orthogonality not to interfere with each other using code division multiplexing (CDM) or frequency division multiplexing (FDM). However, the term DMRS may be replaced with a different term depending on the user's intent and the purpose of use of the reference signal. The term DMRS merely provides a specific example to easily explain the technical content of the disclosure and aid understanding of the present disclosure and is not intended to limit the scope of the disclosure. In other words, it will be apparent to one of ordinary skill in the art that it may be applied to any reference signal based on the technical spirit of the disclosure.

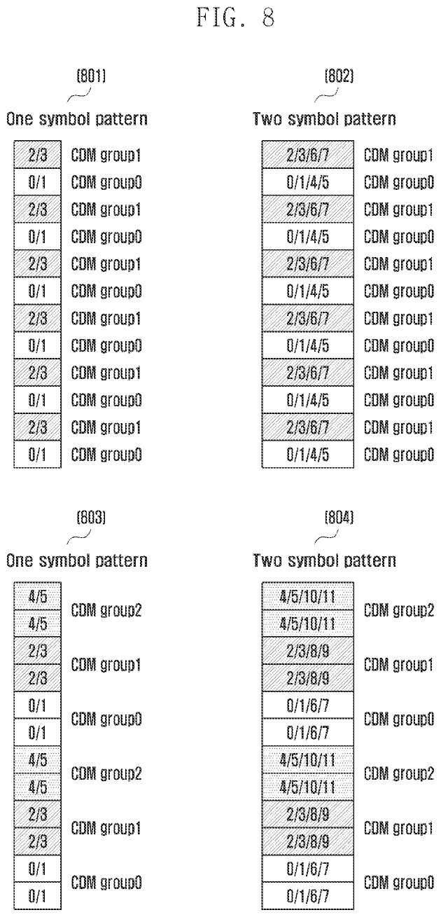

FIG. 8 illustrates a DMRS pattern (type 1 and type 2) used for communication between a base station and a UE in a wireless communication system according to an embodiment of the present disclosure.

In the 5G system, two DMRS patterns may be supported. FIG. 8 illustrates two DMRS patterns.

With reference to FIG. 8, reference numerals 801 and 802 correspond to DMRS type 1, where reference numeral 801 denotes a 1 symbol pattern and reference numeral 802 denotes a 2 symbol pattern. DMRS type 1 of reference numerals 801 and 802 is a comb 2-structure DMRS pattern and may be composed of two CDM groups. The different CDM groups may be FDMed.

In the 1 symbol pattern 801, frequency CDM is applied to the same CDM group, distinguishing the two DMRS ports. Therefore, a total of 4 orthogonal DMRS ports may be configured. The 1 symbol pattern 801 may include a DMRS port ID mapped to each CDM group (DMRS port ID for downlink may be represented by the shown number+1000). In the 2 symbol pattern 802, time/frequency CDM is applied to the same CDM group, distinguishing the four DMRS ports. Therefore, a total of 8 orthogonal DMRS ports may be configured. The 2 symbol pattern 802 may include a DMRS port ID mapped to each CDM group (DMRS port ID for downlink may be represented by the shown number+1000).

DMRS type2 indicated by reference numerals 803 and 804 is a DMRS pattern having a structure in which frequency domain orthogonal cover codes (FD-OCC) are applied to subcarriers adjacent in frequency, and may be composed of three CDM groups. The different CDM groups may be FDMed.

In the 1 symbol pattern 803, frequency CDM is applied to the same CDM group, distinguishing the two DMRS ports. Therefore, a total of 6 orthogonal DMRS ports may be configured. The 1 symbol pattern 803 may include a DMRS port ID mapped to each CDM group (DMRS port ID for downlink may be represented by the shown number+1000). In the 2 symbol pattern 804, time/frequency CDM is applied to the same CDM group, distinguishing the four DMRS ports. Therefore, a total of 12 orthogonal DMRS ports may be configured. The 2 symbol pattern 804 may include a DMRS port ID mapped to each CDM group (DMRS port ID for downlink may be represented by the shown number+1000).

As described above, in the NR system, two different DMRS patterns (e.g., DMRS patterns 801 and 802 or DMRS patterns 803 and 804) may be configured. Whether each DMRS pattern is a one symbol pattern 801 or 803 or an adjacent-two-symbol pattern 802 or 804 may also be configured. Further, in the NR system, not only DMRS port numbers are scheduled, but also the number of CDM groups scheduled together may be configured and signaled for PDSCH rate matching. Further, in the case of cyclic prefix based orthogonal frequency division multiplex (CP-OFDM), both the DMRS patterns described above may be supported in DL and UL. In the case of discrete Fourier transform spread OFDM (DFT-S-OFDM), only DMRS type1 among the DMRS patterns described above may be supported in UL.

Further, it may be supported to configure additional DMRSs. Front-loaded DMRS refers to the first DMRS transmitted/received in the first symbol in the time domain among DMRSs, and additional DMRS refers to a DMRS transmitted/received in a symbol behind the front-loaded DMRS in the time domain. In the NR system, the number of additional DMRSs may be configured from a minimum of 0 to a maximum of 3. Further, in case where an additional DMRS is configured, the same pattern as the front-loaded DMRS may be assumed. In an embodiment, when information about whether the DMRS pattern type described above for the front-loaded DMRS is type 1 or type 2, information about whether the DMRS pattern is a one-symbol pattern or an adjacent-two-symbol pattern, and information about the number of DMRS ports and used CDM groups are indicated, in case where an additional DMRS is further configured, it may be assumed that the additional DMRS has the same DMRS information as the front-loaded DMRS configured.

In an embodiment, the downlink DMRS configuration described above may be configured through RRC signaling as shown in Table 6.

```
TABLE 6
    DMRS-DownlinkConfig ::= SEQUENCE {
    dmrs-Type ENUMERATED {type2} OPTIONAL, -- Need S
      dmrs-AdditionalPosition ENUMERATED {pos0, pos1, pos3}
OPTIONAL, -- Need S
      maxLength ENUMERATED {len2} OPTIONAL, -- Need S
    scramblingID0 INTEGER (0..65535) OPTIONAL, -- Need S
    scramblingID1 INTEGER (0..65535) OPTIONAL, -- Need S
    phaseTrackingRS SetupRelease {PTRS-DownlinkConfig} OPTIONAL,
-- Need M
      ...
    }
```

Here, dmrs-type may configure the DMRS type, dmrs-AdditionalPosition may configure additional DMRS OFDM symbols, maxLength may configure 1 symbol DMRS pattern or 2 symbol DMRS pattern, scramblingID0 and scramblingID1 may configure scrambling IDs, and phaseTrackingRS may configure a phase tracking reference signal (PTRS).

Further, the uplink DMRS configuration described above may be configured through RRC signaling as shown in Table 7.

```
TABLE 7
    DMRS-UplinkConfig ::= SEQUENCE {
      dmrs-Type ENUMERATED {type2} OPTIONAL, -- Need S
      dmrs-AdditionalPosition ENUMERATED {pos0, pos1, pos3} OPTIONAL,
-- Need R
      phaseTrackingRS SetupRelease { PTRS-UplinkConfig } OPTIONAL, --
Need M
      maxLength ENUMERATED {len2} OPTIONAL, -- Need S
      transformPrecodingDisabled SEQUENCE {
      scramblingID0 INTEGER (0..65535) OPTIONAL, -- Need S
      scramblingID1 INTEGER (0..65535) OPTIONAL, -- Need S
      ...
      } OPTIONAL, -- Need R
      transformPrecodingEnabled SEQUENCE {
      nPUSCH-Identity INTEGER (0..1007) OPTIONAL, -- Need S
      sequenceGroupHopping ENUMERATED {disabled} OPTIONAL, -- Need
S
      sequenceHopping ENUMERATED {enabled} OPTIONAL, -- Need S
      ...
      } OPTIONAL, -- Need R
      ...
    }
```

Here, dmrs-Type may configure the DMRS type, dmrs-AdditionalPosition may configure additional DMRS OFDM symbols, phaseTrackingRS may configure PTRS, and maxLength may configure 1 symbol DMRS pattern or 2 symbol DMRS pattern. scramblingID0 and scramblingID1 may configure scrambling ID0s, and nPUSCH-Identity may configure the cell ID for DFT-s-OFDM. sequenceGroupHopping may disable sequence group hopping, and sequenceHopping may enable sequence hopping.

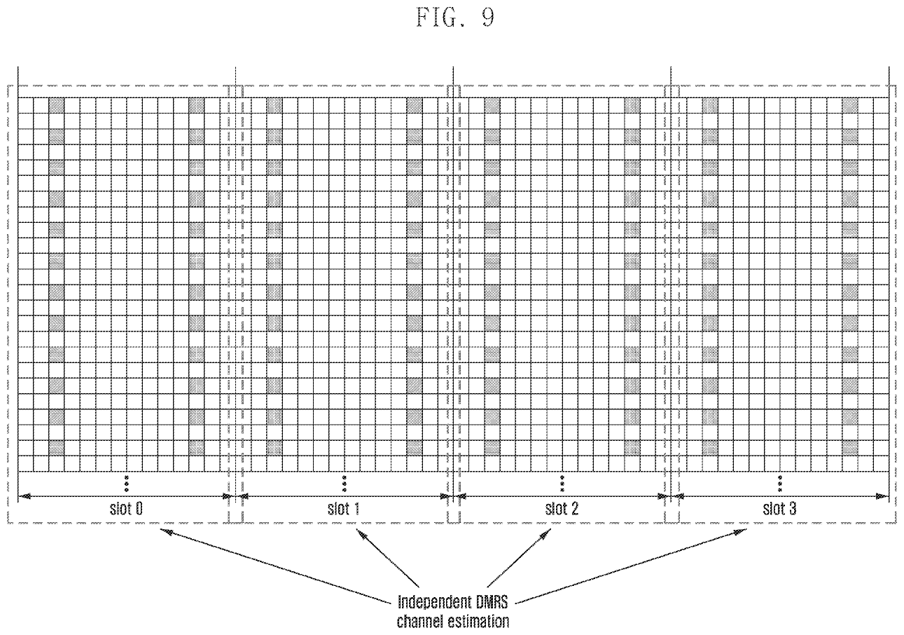

FIG. 9 illustrates an example of channel estimation using a DMRS received in one PUSCH in a time domain of a wireless communication system according to an embodiment of the present disclosure.

With reference to FIG. 9, in performing channel estimation for data decoding by DMRS, channel estimation may be performed within the precoding resource block group (PRG), which is a corresponding bundling unit, by using the physical resource block (PRB) bundling linked to system band in the frequency band. Further, in a unit of time, channel estimation is performed under the assumption that precoding is the same for the DMRS received on only one PUSCH.

Hereinafter, a method for time domain resource allocation (TDRA) for a data channel in a 5G communication system is described. The base station may configure the UE with a table for time domain resource allocation information for a downlink data channel (physical downlink shared channel (PDSCH)) and an uplink data channel (physical uplink shared channel (PUSCH)) via higher layer signaling (e.g., RRC signaling).

For PDSCH, the base station may configure a table including up to maxNrofDL-Allocations=17 entries and, for PUSCH, configure a table including up to maxNrofUL-Allocations=17 entries. The time domain resource allocation information may include at least one of, e.g., PDCCH-to-PDSCH slot timing (which is designated KO and corresponds to the time interval in slot units between the time of reception of the PDCCH and the time of transmission of the PDSCH scheduled by the received PDCCH) or PDCCH-to-PUSCH slot timing (which is designated K2 and corresponds to the time interval in slot units between the time of reception of PDCCH and the time of transmission of the PUSCH scheduled by the received PDCCH), information for the position and length of the start symbol where the PDSCH or PUSCH is scheduled in the slot, and the mapping type of PDSCH or PUSCH.

In an embodiment, time domain resource allocation information for the PDSCH may be configured to the UE through RRC signaling as shown in Table 8 below.

```
TABLE 8
    PDSCH-TimeDomainResourceAllocationList information element
    PDSCH-TimeDomainResourceAllocationList ::= SEQUENCE (SIZE(1..maxNrofDL-
Allocations)) OF PDSCH-TimeDomainResourceAllocation
    PDSCH-TimeDomainResourceAllocation ::= SEQUENCE {
      k0 INTEGER(0..32) OPTIONAL, -- Need S
    mappingType ENUMERATED {typeA, typeB},
    startSymbolAndLength INTEGER (0..127)
    repetitionNumber ENUMERATED {n2, n3, n4, n5, n6, n7, n8, n16} OPTIONAL, --
Cond Formats1-0and1-1
    }
```

Here, k0 may indicate the PDCCH-to-PDSCH timing (i.e., the slot offset between the DCI and the scheduled PDSCH) in each unit of slot, mappingType may indicate the PDSCH mapping type, startSymbolAndLength may indicate the start symbol and length of the PDSCH, and repetitionNumber may indicate the number of PDSCH transmission occasions according to the slot-based repetition scheme.

In an embodiment, time domain resource allocation information for the PUSCH may be configured to the UE through RRC signaling as shown in Table 9 below.

```
TABLE 9
    PUSCH-TimeDomainResourceAllocation information element
    PUSCH-TimeDomainResourceAllocationList ::= SEQUENCE (SIZE(1..maxNrofUL-
Allocations)) OF PUSCH-TimeDomainResourceAllocation
    PUSCH-TimeDomainResourceAllocation ::= SEQUENCE {
      k2 INTEGER(0..32) OPTIONAL, -- Need S
    mappingType ENUMERATED {typeA, typeB},
      startSymbolAndLength INTEGER (0..127)
    }
    PUSCH-Allocation-r16 ::= SEQUENCE {
      mappingType-r16 ENUMERATED {typeA, typeB} OPTIONAL, -- Cond
NotFormat01-02-Or-TypeA
      startSymbolAndLength-r16 INTEGER (0..127) OPTIONAL, -- Cond NotFormat01-
02-Or-TypeA
      startSymbol-r16 INTEGER (0..13) OPTIONAL, -- Cond RepTypeB
      length-r16 INTEGER (1..14) OPTIONAL, -- Cond RepTypeB
      numberOfRepetitions-r16 ENUMERATED  {n1, n2, n3, n4, n7, n8, 12, n16}
OPTIONAL, -- Cond Format01-02
      ...
    }
```

Here, k2 may indicate the PDCCH-to-PUSCH timing (i.e., the slot offset between the DCI and the scheduled PUSCH) in each unit of slot, mappingType may indicate the PUSCH mapping type, startSymbolAndLength or StartSymbol and length may indicate the start symbol and length of the PUSCH, and numberOfRepetitions may indicate the number of repetitions applied to PUSCH transmission.

The base station may indicate, to the UE, at least one of the entries in the table for the time domain resource allocation information through L1 signaling (e.g., downlink control information (DCI)) (which may be indicated with, e.g., the “time domain resource allocation” field in the DCI). The UE may obtain time domain resource allocation information for the PDSCH or PUSCH based on the DCI received from the base station.

Transmission of an uplink data channel (physical uplink shared channel (PUSCH)) in the 5G system is described below. PUSCH transmission may be dynamically scheduled by the UL grant in the DCI (e.g., referred to as dynamic grant (DG)-PUSCH), or may be scheduled by configured grant type 1 or configured grant type 2 (e.g., referred to as configured grant (CG)-PUSCH). Dynamic scheduling for PUSCH transmission may be indicated through, e.g., DCI format 0_0 or 0_1.

PUSCH transmission of configured grant type 1 may be semi-statically configured through reception of configuredGrantConfig including rrc-ConfiguredUplinkGrant of Table 10 through higher layer signaling without reception of the UL grant in the DCI. PUSCH transmission of configured grant type 2 may be semi-persistently scheduled by the UL grant in the DCI after receiving the configuredGrantConfig that does not include rrc-ConfiguredUplinkGrant of Table 10 through higher layer signaling.

In an embodiment, in case where PUSCH transmission is scheduled by the configured grant, parameters applied to PUSCH transmission may be configured through configuredGrantConfig which is the higher layer signaling of Table 10, except for specific parameters (e.g., dataScramblingIdentityPUSCH, txConfig, codebookSubset, maxRank, or scaling of UCI-OnPUSCH) provided through pusch-Config of Table 11 which is higher layer signaling. For example, if the UE receives transformPrecoder through configuredGrantConfig, which is higher layer signaling of Table 10, the UE may apply tp-pi2BPSK in push-Config of Table 11 for PUSCH transmission operated by the configured grant.

```
TABLE 10
    ConfiguredGrantConfig
    ConfiguredGrantConfig ::= SEQUENCE {
      frequencyHopping ENUMERATED {intraSlot, interSlot} OPTIONAL, -- Need S,
      cg-DMRS-Configuration DMRS-UplinkConfig,
      mcs-Table ENUMERATED {qam256, qam64LowSE} OPTIONAL, -- Need S
      mcs-TableTransformPrecoder ENUMERATED {qam256, qam64LowSE}
OPTIONAL, -- Need S
      uci-OnPUSCH SetupRelease { CG-UCI-OnPUSCH } OPTIONAL, -- Need M
      resourceAllocation ENUMERATED { resourceAllocationType0,
resourceAllocationType1, dynamicSwitch },
      rbg-Size ENUMERATED {config2} OPTIONAL, -- Need S
      powerControlLoopToUse ENUMERATED {n0, n1},
      p0-PUSCH-Alpha P0-PUSCH-AlphaSetId,
      transformPrecoder ENUMERATED {enabled, disabled} OPTIONAL, -- Need S
      nrofHARQ-Processes INTEGER(1..17),
      repK ENUMERATED {n1, n2, n4, n8},
      repK-RV ENUMERATED {s1-0231, s2-0303, s3-0000 }OPTIONAL, -- Need
R
      periodicity ENUMERATED {
      sym2, sym7, sym1x14, sym2x14, sym4x14, sym5x14, sym8x14, sym10x14, sym17x14,
sym20x14,
      sym32x14, sym40x14, sym64x14, sym80x14, sym128x14, sym170x14, sym256x14,
sym320x14, sym512x14,
      sym640x14, sym1024x14, sym1280x14, sym2560x14, sym5120x14,
      sym6, sym1x12, sym2x12, sym4x12, sym5x12, sym8x12, sym10x12, sym17x12,
sym20x12, sym32x12,
      sym40x12, sym64x12, sym80x12, sym128x12, sym170x12, sym256x12, sym320x12,
sym512x12, sym640x12,
      sym1280x12, sym2560x12
      },
      configuredGrantTimer INTEGER (1..64) OPTIONAL, -- Need R
      rrc-ConfiguredUplinkGrant SEQUENCE {
      timeDomainOffset INTEGER (0..5119),
      timeDomainAllocation INTEGER (0..16),
      frequencyDomainAllocation BIT STRING (SIZE(18)),
      antennaPort INTEGER (0..31),
      dmrs-SeqInitialization INTEGER (0..1) OPTIONAL, -- Need R
      precodingAndNumberOfLayers INTEGER (0..63),
      srs-ResourceIndicator INTEGER (0..16) OPTIONAL, -- Need R
      mcsAndTBS INTEGER (0..31),
      frequencyHoppingOffset INTEGER (1.. maxNrofPhysicalResourceBlocks−1)
OPTIONAL, -- Need R
      pathlossReferenceIndex INTEGER (0..maxNrofPUSCH-PathlossReferenceRSs−
1),
      ...
      } OPTIONAL, -- Need R
      ...
    }
```

Next, a PUSCH transmission method is described. The DMRS antenna port for PUSCH transmission may be the same as the antenna port for SRS transmission. PUSCH transmission may follow a codebook-based transmission method and a non-codebook-based transmission method, respectively, depending on whether the value of txConfig in push-Config of Table 7, which is higher signaling, is “codebook” or “nonCodebook.” As described above, PUSCH transmission may be dynamically scheduled through DCI format 0_0 or 0_1 or be semi-statically configured by the configured grant.

If the UE is instructed to schedule PUSCH transmission through DCI format 0_0, the UE may perform beam configuration for PUSCH transmission using the pucch-spatialRelationInfoID corresponding to UE-specific (dedicated) PUCCH resource having the lowest ID in the activated uplink bandwidth part (BWP) in the serving cell. In an embodiment, PUSCH transmission may be performed based on a single antenna port. The UE may not expect scheduling for PUSCH transmission through DCI format 0_0 in a BWP in which PUCCH resource including pucch-spatialRelationInfo is not configured. If the UE has not had txConfig in push-Config of Table 11 configured thereto, the UE may not expect to be scheduled through DCI format 0_1.

```
TABLE 11
    PUSCH-Config
    PUSCH-Config ::= SEQUENCE {
      dataScramblingIdentityPUSCH INTEGER (0..1023) OPTIONAL, -- Need S
      txConfig ENUMERATED {codebook, nonCodebook} OPTIONAL, -- Need S
      dmrs-UplinkForPUSCH-MappingTypeA SetupRelease { DMRS-UplinkConfig }
OPTIONAL, -- Need M
      dmrs-UplinkForPUSCH-MappingTypeB SetupRelease { DMRS-UplinkConfig }
OPTIONAL, -- Need M
      pusch-PowerControl PUSCH-PowerControl OPTIONAL, -- Need M
      frequencyHopping ENUMERATED {intraSlot, interSlot} OPTIONAL, -- Need
S
      frequencyHoppingOffsetLists SEQUENCE (SIZE (1..4)) OF INTEGER (1..
maxNrofPhysicalResourceBlocks−1) OPTIONAL, -- Need M
      resourceAllocation ENUMERATED { resourceAllocationType0,
resourceAllocationType1, dynamicSwitch},
      pusch-TimeDomainAllocationList SetupRelease { PUSCH-
TimeDomainResourceAllocationList } OPTIONAL, -- Need M
      pusch-AggregationFactor ENUMERATED { n2, n4, n8 } OPTIONAL, -- Need
S
      mcs-Table ENUMERATED {qam256, qam64LowSE }OPTIONAL, -- Need S
      mcs-TableTransformPrecoder ENUMERATED {qam256, qam64LowSE}
OPTIONAL, -- Need S
      transformPrecoder ENUMERATED {enabled, disabled} OPTIONAL, -- Need S
      codebookSubset ENUMERATED {fullyAndPartialAndNonCoherent,
partialAndNonCoherent,nonCoherent}
        OPTIONAL, -- Cond codebookBased
      maxRank INTEGER (1..4) OPTIONAL, -- Cond codebookBased
      rbg-Size ENUMERATED { config2} OPTIONAL, -- Need S
      uci-OnPUSCH SetupRelease { UCI-OnPUSCH} OPTIONAL, -- Need M
      tp-pi2BPSK ENUMERATED {enabled} OPTIONAL, -- Need S
      ...
    }
```

Next, codebook-based PUSCH transmission is described. Codebook-based PUSCH transmission may be dynamically scheduled through DCI format 0_0 or 0_1 or be semi-statically operated by the configured grant. If dynamically scheduled by codebook-based PUSCH DCI format 0_1 or semi-statically configured by configured grant, the UE may determine a precoder for PUSCH transmission based on the SRS resource indicator (SRI), transmission precoding matrix indicator (TPMI), and transmission rank (number of PUSCH transmission layers).

In an embodiment, the SRI may be given through a field SRS resource indicator in the DCI or configured through srs-ResourceIndicator, which is higher signaling. The UE may have at least one SRS resource, e.g., up to two SRS resources, configured thereto upon codebook-based PUSCH transmission. In case where the UE receives the SRI through the DCI, the SRS resource indicated by the corresponding SRI may mean the SRS resource corresponding to the SRI among SRS resources transmitted prior to the PDCCH including the corresponding SRI. Further, the TPMI and transmission rank may be given through the field precoding information and number of layers in the DCI or configured through precodingAndNumberOfLayers, which is higher level signaling. The TPMI may be used to indicate the precoder applied to PUSCH transmission.

The precoder to be used for PUSCH transmission may be selected from an uplink codebook having the same number of antenna ports as the nrofSRS-Ports value in SRS-Config, which is higher signaling. In codebook-based PUSCH transmission, the UE may determine a codebook subset based on the TPMI and codebookSubset in push-Config, which is higher signaling. In an embodiment, codebookSubset in push-Config, which is higher signaling, may be configured to one of “fullyAndPartialAndNonCoherent,” “partialAndNonCoherent,” and “nonCoherent” based on the UE capability reported by the UE to the base station.

If the UE reports “partialAndNonCoherent” as the UE capability, the UE may not expect the value of codebookSubset, which is higher signaling, to be configured to “fullyAndPartialAndNonCoherent.” Further, if the UE reports “nonCoherent” as the UE capability, the UE may not expect the value of codebookSubset, which is higher signaling, to be configured to “fullyAndPartialAndNonCoherent” or “partialAndNonCoherent.” In case where nrofSRS-Ports in SRS-ResourceSet, which is higher signaling, indicates two SRS antenna ports, the UE may not expect the value of codebookSubset, which is higher signaling, to be configured to “partialAndNonCoherent.”

The UE may have one SRS resource set, in which the value of usage in SRS-ResourceSet, which is higher signaling, is configured to “codebook,” configured thereto, and one SRS resource in the corresponding SRS resource set may be indicated through the SRI. If several SRS resources are configured in the SRS resource set in which the usage value in the SRS-ResourceSet, which is higher signaling, is configured to “codebook,” the UE may expect the same value to be configured for all SRS resources in the nrofSRS-Ports value in the SRS-Resource, which is higher signaling.

The UE may transmit one or a plurality of SRS resources included in the SRS resource set in which the value of usage is configured to “codebook” according to higher signaling to the base station, and the base station may select one of the SRS resources transmitted by the UE and instruct the UE to perform PUSCH transmission using transmission beam information about the corresponding SRS resource. In an embodiment, in codebook-based PUSCH transmission, the SRI is used as information for selecting an index of one SRS resource and may be included in the DCI. Additionally, the base station may include information indicating the TPMI and rank to be used by the UE for PUSCH transmission in the DCI and transmit it. The UE may perform PUSCH transmission by applying the precoder indicated by the rank and TPMI indicated by the transmission beam of the SRS resource using the SRS resource indicated by the SRI.

Next, non-codebook-based PUSCH transmission is described. Non-codebook-based PUSCH transmission may be dynamically operated through DCI format 0_0 or 0_1 or be semi-statically configured by the configured grant. In case where at least one SRS resource is configured in the SRS resource set in which the value of usage in the SRS-ResourceSet, which is higher signaling, is configured to “nonCodebook,” the UE may be scheduled for non-codebook based PUSCH transmission through DCI format 0_1.

For the SRS resource set in which the value of usage in the SRS-ResourceSet, which is higher signaling, is configured to “nonCodebook,” the UE may have a non-zero power (NZP) CSI-RS resource associated with one SRS resource set configured thereto. The UE may perform calculation on the precoder for SRS transmission through measurement of the NZP CSI-RS resource configured in association with the SRS resource set. If the difference between the last received symbol of the aperiodic NZP CSI-RS resource associated with the SRS resource set and the first symbol of aperiodic SRS transmission in the UE is smaller than specific symbols (e.g., 42 symbols), the UE may not expect that information about the precoder for SRS transmission is updated.

When the value of resource Type in SRS-ResourceSet, which is higher signaling, is configured to “aperiodic,” the NZP CSI-RS associated with the SRS-ResourceSet may be indicated by an SRS request, which is a field in DCI format 0_1 or 1_1. In an embodiment, in case where the NZP CSI-RS resource associated with the SRS-ResourceSet is an aperiodic NZP CSI resource and the value of the field SRS request in DCI format 0_1 or 1_1 is not “00,” it may indicate that the NZP CSI-RS associated with the SRS-ResourceSet is present. The DCI may not indicate cross carrier or cross BWP scheduling. In case where the value of the SRS request indicates the presence of the NZP CSI-RS, the NZP CSI-RS may be positioned in the slot in which the PDCCH including the SRS request field is transmitted. TCI states configured in the scheduled subcarrier may not be configured to QCL-typeD.

If a periodic or semi-persistent SRS resource set is configured, the NZP CSI-RS associated with the SRS resource set may be indicated through associatedCSI-RS in the SRS-ResourceSet, which is higher signaling. For non-codebook-based transmission, the UE may not expect spatialRelationInfo, which is higher signaling for SRS resource, and associatedCSI-RS in SRS-ResourceSet, which is higher signaling, to be configured together.

In case where a plurality of SRS resources is configured to the UE, the UE may determine the precoder and transmission rank to be applied to PUSCH transmission based on the SRI indicated by the base station. In an embodiment, the SRI may be indicated through a field SRS resource indicator in the DCI or be configured through srs-ResourceIndicator, which is higher signaling. Like the above-described codebook-based PUSCH transmission, in case where the UE receives the SRI through the DCI, the SRS resource indicated by the corresponding SRI may mean the SRS resource corresponding to the SRI among SRS resources transmitted prior to the PDCCH including the corresponding SRI. The UE may use one or a plurality of SRS resources for SRS transmission. The maximum number of SRS resources and the maximum number of SRS resources that may be simultaneously transmitted in the same symbol within one SRS resource set may be determined by the UE capability reported by the UE to the base station. The SRS resources transmitted simultaneously by the UE may occupy the same RB. The UE may configure one SRS port for each SRS resource. Only one SRS resource set in which the value of usage in the SRS-ResourceSet, which is higher signaling, is configured to “nonCodebook” may be configured, and up to 4 SRS resources may be configured for non-codebook-based PUSCH transmission.

The base station may transmit one NZP CSI-RS associated with the SRS resource set to the UE, and the UE may calculate the precoder to be used for transmission of one or a plurality of SRS resources in the SRS resource set based on the measurement result upon NZP CSI-RS reception. The UE may apply the calculated precoder when transmitting one or a plurality of SRS resources in the SRS resource set with usage configured to “nonCodebook” to the base station, and the base station may select one or a plurality of SRS resources among one or a plurality of SRS resources received. In non-codebook based PUSCH transmission, the SRI may indicate an index that may represent a combination of one or a plurality of SRS resources, and the SRI may be included in the DCI. The number of SRS resources indicated by the SRI transmitted by the base station may be the number of transmission layers of the PUSCH. The UE may apply the precoder applied to SRS resource transmission to each layer and transmit the PUSCH.

A single TB transmission method through repeated transmission of an uplink data channel (PUSCH) and multiple slots in a 5G system is described below. The 5G system may support two types (e.g., PUSCH repeated transmission type A and PUSCH repeated transmission type B) of repeated transmission methods of uplink data channel and TB processing over multi-slot PUSCHs (TBoMS) that transmits multiple PUSCHs over multi-slot PUSCH for a single TB. Further, the UE may have either PUSCH repeated transmission type A or B configured thereto by higher layer signaling. Further, the UE may have a numberOfSlotsTBOMS' configured thereto through the resource allocation table and transmit the TBoMS.

### PUSCH Repeated Transmission Type-A

As described above, as the time domain resource allocation method in one slot, the start symbol and length of the uplink data channel may be determined, and the base station may transmit the number of repeated transmissions to the UE through higher layer signaling (e.g., RRC signaling) or L1 signaling (e.g., DCI). To determine the TBS, the number N of the slots configured to numberOfSlotsTBoMS may be-.
The UE may repeatedly transmit uplink data channels, which are identical in start symbol and length to the configured uplink data channel, in consecutive slots based on the number of repeated transmissions received from the base station. In an embodiment, in case where at least one symbol in the slot for uplink data channel repeated transmission configured to the UE or the slot configured to the UE in the downlink by the base station is configured in the downlink, the UE may omit uplink data channel transmission in the corresponding slot. For example, the UE may not transmit uplink data channel within the number of repeated transmissions of uplink data channel. In contrast, the UE supporting Rel-17 uplink data repeated transmission may determine that the slot capable of uplink data repeated transmission is an available slot, and count the number of transmissions upon uplink data channel repeated transmission for the slot determined to be an available slot. In case where the uplink data channel repeated transmission determined to be an available slot is omitted, it may be postponed, and then, be repeatedly transmitted through a transmittable slot. By use of Table 12 below, a redundancy version may be applied according to the redundancy version pattern configured for each nth PUSCH transmission occasion.

### PUSCH Repeated Transmission Type-B

As described above, as the time domain resource allocation method in one slot, the start symbol and length of the uplink data channel may be determined, and the base station may transmit the number of repeated transmissions, numberofrepetitions, to the UE through higher layer signaling (e.g., RRC signaling) or L1 signaling (e.g., DCI). In an embodiment, to determine the TBS, the number N of the slots configured to numberOfSlotsTBoMS may be-.
First, the nominal repetition of the uplink data channel may be determined as follows based on the start symbol and length of the uplink data channel configured above. Here, nominal repetition may mean the resources of the symbols configured by the base station for repeated PUSCH transmission. The UE may determine resources available for uplink in the configured nominal repetition. In this case, the slot where the nth nominal repetition starts may be given by Kₛ+└S+n·L/N_{symb}^{slot}┘, and the symbol where the nominal repetition starts in the start slot may be given by mod(S+n·L, Nₛₗₒₜ^{symb}). The slot where the nth nominal repetition ends may be given by └Kₛ+└S+(n+1)·L−1/N_{symb}^{slot}┘, and the symbol where the nominal repetition ends in the last slot may be given by mod(S+(n+1)·L−1·N_{symb}^{slot}). Here, n=0, . . . , numberofrepetitions−1, S may indicate the start symbol of the configured uplink data channel, and L may indicate the symbol length of the configured uplink data channel. Kₛ may indicate the slot in which PUSCH transmission starts, and N_{symb}^{slot} may indicate the number of symbols per slot.
The UE may determine an invalid symbol for PUSCH repeated transmission type B. The symbol configured as downlink by tdd-UL-DL-ConfigurationCommon or tdd-UL-DL-ConfigurationDedicated may be determined to be an invalid symbol for PUSCH repeated transmission type B. Additionally, the invalid symbol may be configured based on the higher layer parameter (e.g., InvalidSymbolPattern). As an example, as the higher layer parameter (e.g., InvalidSymbolPattern) provides a symbol level bitmap over one or two slots, an invalid symbol may be configured. In an embodiment, in the bitmap, 1 may indicate an invalid symbol. Additionally, the periodicity and pattern of the bitmap may be configured through the higher layer parameter (e.g., periodicity AndPattern). If the higher layer parameter (e.g., InvalidSymbolPattern) is configured, and InvalidSymbolPatternIndicator-ForDCIFormat0_1 or InvalidSymbolPatternIndicator-ForDCIFormat0_2 parameter indicates 1, the UE may apply the invalid symbol pattern and, if it indicates 0, the UE may not apply the invalid symbol pattern. Alternatively, if the higher layer parameter (e.g., InvalidSymbolPattern) is configured, and InvalidSymbolPatternIndicator-ForDCIFormat0_1 or InvalidSymbolPatternIndicator-ForDCIFormat0_2 parameter is not configured, the UE may apply the invalid symbol patter-.
After the invalid symbol is determined in each nominal repetition, the UE may consider symbols other than the determined invalid symbol as valid symbols. If each nominal repetition includes one or more valid symbols, the nominal repetition may include one or more actual repetitions. Here, each actual repetition may mean the symbol actually used for PUSCH repeated transmission among the symbols configured in the configured nominal repetition, and may include consecutive sets of valid symbols that may be used for PUSCH repeated transmission type B in one slot. In case where the actual repetition having one symbol is configured to valid except the case where the symbol length L of the configured uplink data channel is 1, the UE may omit the actual repetition transmission. By use of Table 8 below, a redundancy version may be applied according to the redundancy version pattern configured for each nth actual repetition.

### TB Processing Over Multiple Slots (TBoMS)

As described above, as the time domain resource allocation method in one slot, the start symbol and length of the uplink data channel may be determined, and the base station may transmit the number of repeated transmissions to the UE through higher layer signaling (e.g., RRC signaling) or L1 signaling (e.g., DCI). In an embodiment, the TBS may be determined using the N value greater than or equal to 1, the number of slots configured as numberOfSlotsTBoMS.
The UE may transmit uplink data channels, which are identical in start symbol and length to the configured uplink data channel, in consecutive slots based on the number of repeated transmissions and the number of slots for determining the TBS, received from the base station. In an embodiment, in case where at least one symbol in the slot for uplink data channel repeated transmission configured to the UE or the slot configured to the UE in the downlink by the base station is configured in the downlink, the UE may omit uplink data channel transmission in the corresponding slot. For example, it may be included in the number of uplink data channel repeated transmissions, but may not be transmitted.

In contrast, the UE supporting Rel-17 uplink data repeated transmission may determine that the slot capable of uplink data repeated transmission is an available slot, and count the number of transmissions upon uplink data channel repeated transmission for the slot determined to be an available slot. In case where the uplink data channel repeated transmission determined to be an available slot is omitted, it may be postponed, and then, be repeatedly transmitted through a transmittable slot. In an embodiment, by use of Table 12 below, a redundancy version may be applied according to the redundancy version pattern configured for each nth PUSCH transmission occasion.

TABLE 12

| | rv_{id} to be applied to n^{th} transmission occasion | | | |
|---|---|---|---|---|
| rv_{id} | (repetition Type A) or TB processing over multiple | | | |
| indicated by | slots) or n^{th} actual repetition (repetition Type B) | | | |
| the DCI | ((n − (n | ((n − (n | ((n − (n | ((n − (n |
| scheduling | mod N))/N) | mod N))/N) | mod N))/N) | mod N))/N) |
| the PUSCH | mod 4 = 0 | mod 4 = 0 | mod 4 = 0 | mod 4 = 0 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

A method for determining an uplink available slot for single or multi-PUSCH transmission in a 5G system is described below.

In an embodiment, if AvailableSlotCounting is configured to enable in the UE, the UE may determine the available slot based on tdd-UL-DL-ConfigurationCommon, tdd-UL-DL-ConfigurationDedicated, ssb-PositionsInBurst and a time domain resource allocation (TDRA) information field value, for type A PUSCH repeated transmission and TBoMS PUSCH transmission. In other words, in case where at least one symbol configured with the TDRA for PUSCH in the slot for PUSCH transmission overlaps at least one symbol for other purposes than uplink transmission, the slot may be determined to be an unavailable slot.

Hereinafter, a method for reducing SSB density through dynamic signaling to reduce energy consumption of a base station in the 5G system is described.

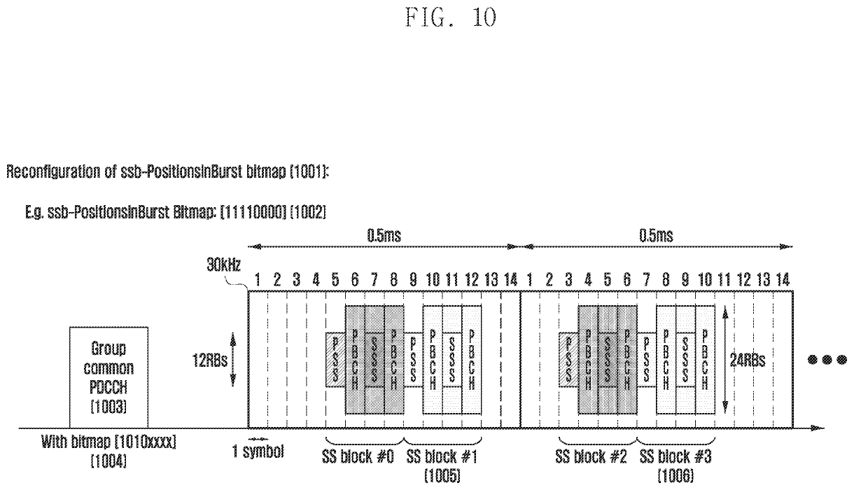

FIG. 10 illustrates an example of a method for reconfiguring SSB transmission through dynamic signaling of a wireless communication system according to an embodiment of the present disclosure.

With reference to FIG. 10, in case where the UE may have ssb-PositionsInBurst=“11110000” (1002) configured thereto through higher layer signaling (SIB1 or ServingCellConfigCommon) from the base station, and up to two synchronization signal block at a subcarrier spacing of 30 kHz may be transmitted within 0.5 ms (or in case where one slot is composed of 14 OFDM symbols, it corresponds to a length of one slot), and accordingly, the UE may receive four synchronization signal blocks (SSBs) within 1 ms (or, in case where 1 slot is composed of 14 OFDM symbols, it corresponds to a length of 2 slots). In this case, to reduce SSB transmission density to save energy, the base station may broadcast the bitmap “1010xxxx” (1004) through the group/Cell common DCI 1003 having the network energy saving-radio network temporary identifier (nwes-RNTI) (or, es-RNTI), reconfiguring SSB transmission configuration information. In this case, transmission of SS block #1 1005 and SS block #3 1006 may be canceled based on the bitmap 1004 configured through the Group/Cell common DCI. FIG. 10 provides a method (1001) for reconfiguring SSB transmission through bitmap-based group/cell common DCI.

Additionally, the base station may reconfigure the ssb-periodicity configured through higher layer signaling through group/cell common DCI. In addition, by additionally configuring Timer information to indicate when to apply Group/Cell common DCI, SSB may be transmitted through SSB transmission information reconfigured to Group/Cell common DCI during the configured timer. Then, when the timer ends, the base station may operate with SSB transmission information configured to existing higher layer signaling. This changes the configuration from normal mode to energy saving mode through a timer, thereby reconfiguring the SSB configuration information. As another method, the base station may configure the application time and period of SSB configuration information reconfigured through Group/Cell common DCI to the UE using Offset and Duration information. Herein, the UE may not monitor the SSB during the Duration from the time the Group/Cell common DCI is received and the Offset is applied.

Hereinafter, a BWP or BW adaptation method through dynamic signaling to reduce energy consumption of the base station in the 5G system is described.

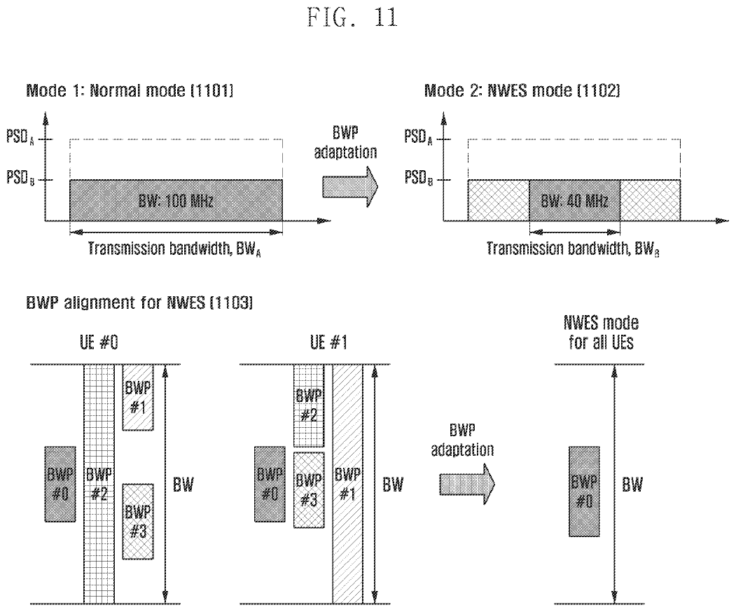

FIG. 11 illustrates an example of a method for reconfiguring BWP and BW through dynamic signaling of a wireless communication system according to an embodiment of the present disclosure.

With reference to FIG. 11, the UE may operate as BWP or BW activated through higher layer signaling and L1 signaling from the base station (1101). For example, the UE may operate with a fixed power PSDB through full BW of 100 MHz. In this case, the base station may adjust the BW and BWP to activate a narrower BW of 40 MHz for the UE with the same power PSDB for energy saving (1102). In this case, the BW or BWP adjustment operation for energy saving of the base station may be configured to equally match the UE-specifically configured BWP and BW configurations through group common DCI and cell specific DCI (1103). For example, UE #0 and UE #1 may have different BWP constitutions and positions. In this case, in order to save energy by reducing the BW used by the base station, the BW and BWP of all UEs may be configured to the same one. In this case, the BWP or BW in the operation for energy saving may be configured to one or more, and this may be used to configure the BWP for each UE Group.

Hereinafter, a DRX alignment method through dynamic signaling to reduce energy consumption of the base station energy in the 5G system is described.

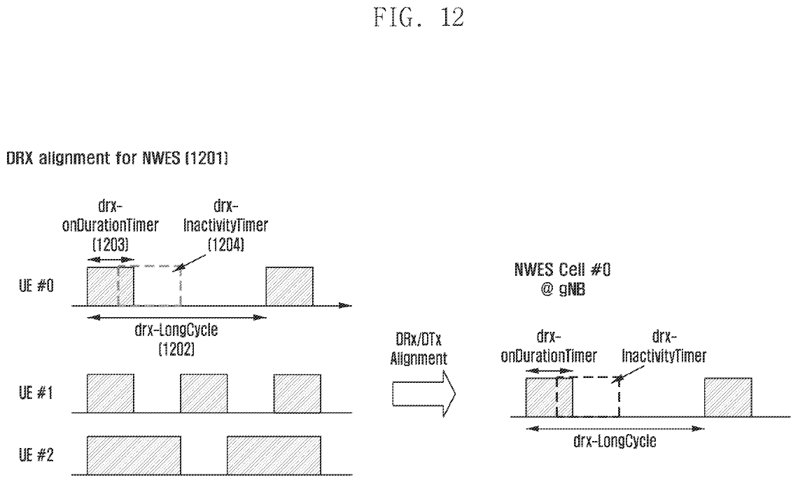

FIG. 12 illustrates an example of a method for reconfiguring DRX through dynamic signaling of a wireless communication system according to an embodiment of the present disclosure.

With reference to FIG. 12, the base station may configure UE-specific DRX through higher layer signaling. For example, each UE may be configured to different drx-LongCycle, drx-ShortCycle, drx-onDurationTimer, and drx-InactivityTimer. Then, the base station may configure UE-specific DRX configuration for energy saving through UE group-specific or cell-specific L1 signaling (1201). Through this, the base station may achieve the same energy saving effect as the UE saves power through DRX.

Hereinafter, discontinuous transmission (DTX) operation to reduce energy consumption of the base station in the 5G system is described

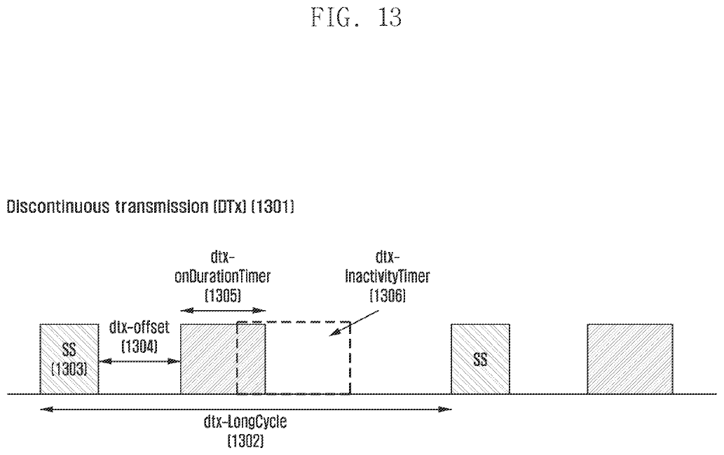

FIG. 13 illustrates a DTX method for energy saving of a base station according to an embodiment of the present disclosure.

With reference to FIG. 13, the base station may configure discontinuous transmission (DTx) for energy saving through higher layer signaling (new system information block (SIB) for DTx or RRC signaling) and L1 signaling (DCI). In this case, the base station may configure a dtx-onDurationTimer 1305 that transmits a PDCCH scheduling DL SCH for DTx operation, or a reference signal for measurement for RRM measurement, beam management, pathloss, and the like, a dtx-InactivityTimer 1306 that receives the PDSCH after receiving the PDCCH scheduling the DL SCH, a synchronization signal (SS) 1303 for synchronization before the dtx-onDurationTimer, a dtx-offset 1304 that configures an offset between the dtx-onDurationTimer after the configuration information SS, and a dtx-(Long)Cycle 1302 for DTx to operate periodically based on the above configuration information. In this case, dtx-cycle may be configured in plural with long cycles and short cycles. During the operation of the DTx, the base station considers a transmitter end to be in an off (or inactive) state, and therefore may not transmit DL CCH, SCH, and DL RS. That is, the base station may transmit downlink (PDCCH, PDSCH, RS, etc.) only during SS, dtx-onDurationTimer, and dtx-InactivityTimer for DTx operation. In this case, SS-gapbetweenBurst or the number of SS bursts may be additionally configured as additional information of the above configured SS.

Hereinafter, a method for activating a base station through a gNB wake-up signal (WUS) during the base station's inactive mode to reduce the energy consumption of the base station in the 5G system.

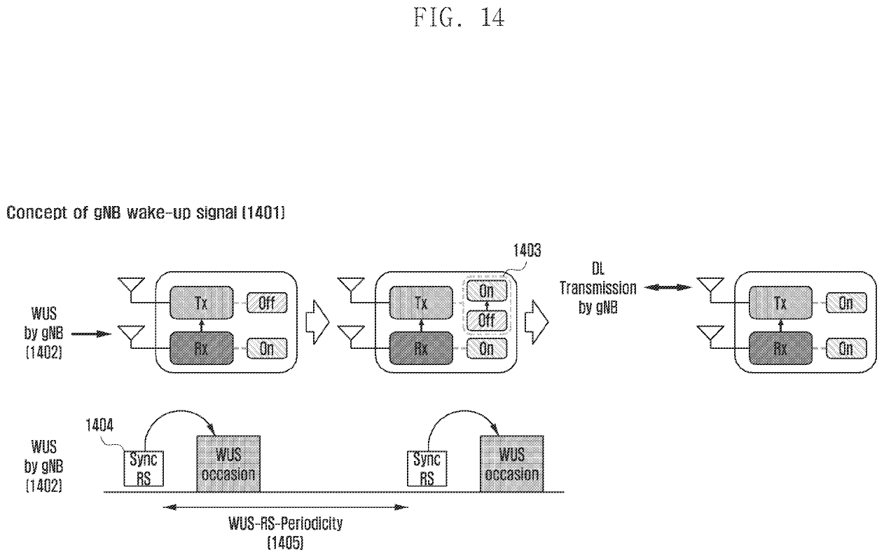

FIG. 14 illustrates an operation of a base station according to a gNB wake-up signal according to an embodiment of the present disclosure.

With reference to FIG. 14, the base station may maintain a transmitter end in an Off (or inactive) state while the base station is in an inactive state (or sleep mode) for energy saving. Then, the base station may receive a gNB wake-up signal 1402 from the UE to activate the sleep mode of the base station. Then, in case where the base station receives WUS from the UE through an Rx end, it may change the Tx end to the On (or active) state (1403). Then, the base station may perform downlink transmission to the UE. In this case, the base station may perform synchronization after Tx on and perform control and data transmission. Additionally, various uplink signals, such as PRACH, scheduling request (SR PUCCH), PUCCH including Ack, etc., may be considered as gNB WUS. Through the above method, the base station may save energy, and at the same time, the UE may improve latency.

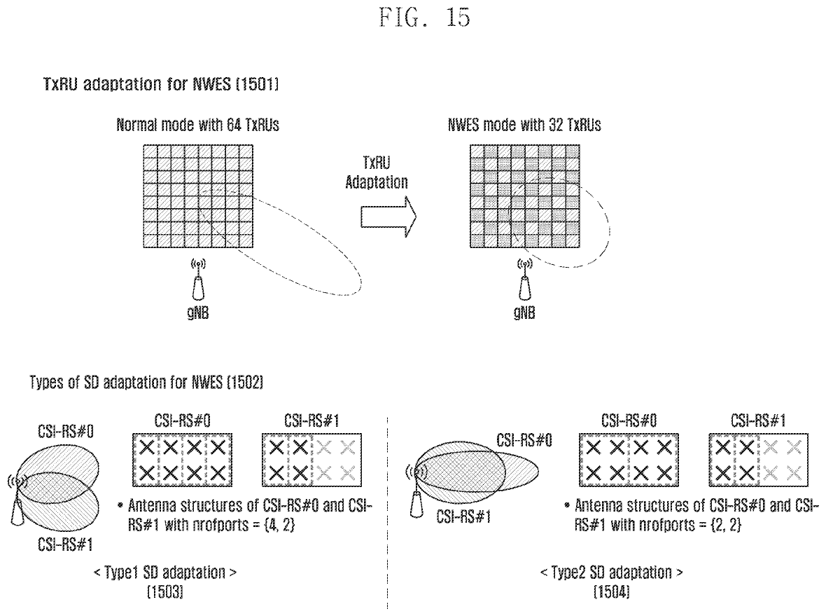

In this case, the base station may configure the WUS occasion for receiving the gNB WUS and the Sync RS for synchronization before the UE transmits the gNB WUS. In this case, in the case of Sync RS, SSB, TRS, Light SSB (PSS+SSS), consecutive SSBs, or new RS (continuous PSS+SSS), etc. may be considered. In the case of WUS, PRACH, PUCCH with SR, sequence based signal, etc. may be considered. The SyncRS 1504 for the UE to activate the inactive mode of the base station for energy saving of the base station and the WUS occasion for receiving WUS may be transmitted repeatedly with WUS-RS periodicity 1405. In the case of FIG. 15, an embodiment is described using 1-to-1 mapping of Sync and WUS occasion as an example, but the disclosure is not limited thereto. For example, Sync and WUS occasion may be N-to-1 mapped, 1-to-N mapped, or N-to-M mapped.

Hereinafter, a method for dynamically turning on/off the spatial domain element (i.e., Antenna, PA or transceiver units or transmission radio units (TxRUs)) of the base station to reduce energy consumption of the base station in the 5G system is described.

FIG. 15 illustrates an antenna adaptation method of a base station for reducing energy consumption in a wireless communication system according to an embodiment of the present disclosure.

With reference to FIG. 15, the base station may adjust the Tx antenna port per RU (radio unit) for energy saving (network energy savings, NWES) (1501). For example, since the base station's PA accounts for most of the base station's energy consumption, the base station may turn off the Tx antenna to save energy. In this case, the base station may refer to/use the UE's reference signal received power (RSRP), channel quality indicator (CQI), and reference signal received quality (RSRQ) to determine whether the Tx antenna may be turned off. The base station may transmit Tx by adjusting the number of activated Tx antennas for each UE group or UE. In this case, the base station may configure information including one or more of beam information according to antenna on/off and reference signal information (e.g., one or more of CSI resource, CSI resource set, and CSI report) to the UE through higher layer signalling (e.g., RRC signaling) or DCI signalling. Additionally, the base station may configure different antenna information for each BWP and reconfigure the antenna information according to BWP changes. Additionally, the base station may receive CSI feedback from the UE to determine whether SD adaptation is possible. The base station may determine SD adaptation (based on CSI feedback). The base station may receive multiple feedbacks from the UE through antenna structure hypotheses of several antenna patterns for SD adaptation.

More specifically, the base station may apply a plurality of types (e.g., two types) of SD adaptation for energy saving (1502). For example, the plurality of types may include Type 1 SD adaptation 1503 and Type 2 SD adaptation 1504.

When the Type 1 SD adaptation 1503 is applied, the base station may adapt the number of antenna ports while maintaining the number of physical antenna elements per antenna port (i.e., logical port). In this case, RF characteristics (e.g., tx power, beam) per port may be the same. Therefore, the UE may perform measurement by combining CSI-RSs of the same corresponding ports during CSI measurement (e.g., L1-RSRP (layer 1-RSRP), L3-RSRP (layer 3-RSRP, etc.).

As another method, when the Type 2 SD adaptation 1504 is applied, the base station may have the same number of antenna ports (i.e., logical ports) and turn on/off the physical antenna element per port. In this case, the RF characteristic per port may vary. During CSI measurement, the UE may distinguish between CSI-RSs of the same port and perform measurement individually. The base station may save energy through one or more of a plurality of types of SD adaptation methods, including the above two types of SD adaptation methods.

Through the methods according to the above embodiment, energy consumption of the base station may be reduced. Additionally, the methods according to the above embodiment may be configured/used as one or may be configured/used simultaneously through a combination of more than one method.

According to an embodiment of the disclosure, a method may be provided for the base station to receive CSI feedback from the UE in order to perform SD adaptation to reduce energy consumption. In addition, according to an embodiment of the disclosure, the base station may be provided with one or multiple CSI resources and/or CSI resource sets and/or one or multiple CSI report configuration methods for receiving CSI feedback from the UE. According to an embodiment of the disclosure, a threshold based CSI report method may be provided to reduce the overhead of CSI measurement and reporting of the UE. According to an embodiment of the disclosure, energy consumption can be reduced without deteriorating coverage and service performance by applying appropriate SD adaptation for each UE, and the CSI feedback overhead of the UE can also be improved. In the disclosure, energy saving, saving energy consumption, reducing energy consumption, etc. may be used interchangeably and may be understood to have the same meaning. Unless specifically stated otherwise, in the disclosure, CSI-RS resource configuration may include CSI-RS resource set configuration. For example, CSI-RS resource configuration may be performed based on CSI-RS resource set configuration.

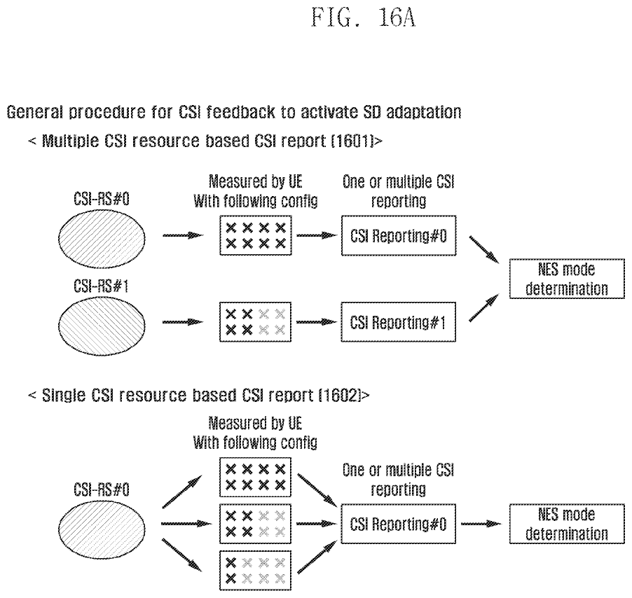

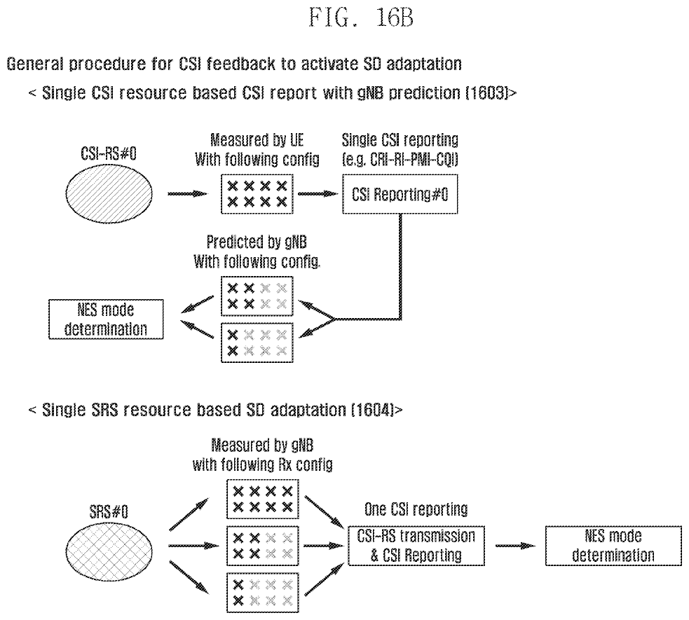

FIGS. 16A and 16B illustrate examples of a method for receiving CSI feedback for each UE to determine SD adaptation of a base station in a wireless communication system according to an embodiment of the disclosure.

With reference to FIGS. 16A and 16B, according to an embodiment, the base station may determine SD adaptation based on CSI feedback for each UE. For example, this may be for energy saving. According to an embodiment, the base station may determine a network energy savings (NES) mode based on CSI feedback, and determining the NES mode may include determining SD adaptation. The base station may obtain CSI feedback to determine an antenna pattern appropriate/suitable for SD adaptation for each UE using one or a combination of one or more of the following methods.

### [Method 1]—Multiple CSI Resource Based CSI Report (1601)

According to Method 1 (1601) according to an embodiment, a multiple CSI reporting method through multiple CSI-RS measurement may be provided. For example, this may be for energy saving of the base station.

The base station may configure multiple CSI resources (and/or CSI resource set) and CSI report configuration with different antenna structures to the UE through higher layer signaling. The UE may measure different CSI-RSs, respectively and perform CSI report with CSI feedback through different or the same PUCCH or PUSCH. The UE may obtain different CSI feedbacks by measuring different CSI-RSs, respectively. The UE may transmit (multiple) CSI reports based on different CSI feedbacks through the same PUCCH (or the same PUSCH) or through different PUCCHs (or different PUSCHs), respectively. Then, the base station may determine SD adaptation for energy saving through the multiple CSI reports.

For example, the base station may configure a CSI resource corresponding to CSI-RS #0 and a CSI resource corresponding to CSI-RS #1 through higher layer signaling. The UE may report CSI reporting #0, which includes CSI measurement measured based on CSI-RS #0, and may report CSI reporting #1, which includes CSI measurement measured based on CSI-RS #1. The base station may perform NES mode determination based on reported CSI reporting #0 and CSI reporting #1.

According to Method 1 (1601) according to an embodiment, the base station may receive CSI feedback for multi-SD adaptation. Method 1 (1601) according to an embodiment may be a suitable method for determining the Type 2 SD adaptation with different RF characteristics. According to Method 1 (1601) according to an embodiment, the base station may transmit multiple CSI-RSs and receive multiple CSI reports. Additionally, the base station may configure each CSI resource for multiple CSI-RS transmissions and CSI reporting for multiple CSI reports. Additionally, the UE may perform measurements multiple times and report multiple CSI reports.

### [Method 2]-Single CSI Resource Based CSI Report (1602)

According to Method 2 (1602) according to an embodiment, a multiple CSI reporting method through single CSI-RS measurement may be provided. For example, this may be for energy saving of the base station.

The base station may configure a single CSI resource configuration for SD adaptation and a CSI report configuration including one or multiple antenna structure configurations through higher layer signaling to the UE. The base station may transmit a single CSI-RS to receive CSI feedback for SD adaptation. The CSI-RS may be a CSI-RS for one or multiple CSI report configurations. The UE may perform measurement of a single CSI-RS transmission multiple times by considering various antenna structure assumptions (which may correspond to multiple antenna structure configurations) and CSI-RS patterns based on the configured CSI report configuration. Then, the UE may report the measurement results obtained through multiple antenna structure assumptions through one or multiple PUCCHs or one or multiple PUSCHs. The UE may obtain multiple CSI feedbacks by measuring a single CSI-RS multiple times based on one or multiple CSI report configurations. The UE may transmit (multiple) CSI reports based on multiple CSI feedbacks through the same PUCCH (or the same PUSCH) or through different PUCCHs (or different PUSCHs), respectively. The base station may apply appropriate SD adaptation to the UE based on the CSI report received from the UE.

For example, the base station may configure a CSI resource corresponding to CSI-RS #0 through higher layer signaling. The UE may report CSI reporting #0, which includes a plurality of CSI measurements measured based on CSI-RS #0. The base station may perform NES mode determination based on the reported CSI reporting #0.

According to Method 2 (1602) according to an embodiment, the base station may determine SD adaptation for energy saving. Method 2 (1602) according to an embodiment may be applied for Type 1 SD adaptation in which the RF characteristic remains the same. According to Method 2 (1602) according to an embodiment, overhead for CSI-RS transmission may be reduced with a single CSI-RS transmission. According to Method 2 (1602) according to an embodiment, the UE may perform CSI reporting by considering multiple antenna patterns.

[Method 3]-Single CSI Resource Based CSI Report with gNB Prediction (1603)

According to Method 3 (1603) according to an embodiment, a CSI feedback prediction method considering the multi-antenna structure of the base station may be provided. This may be for energy saving of the base station.

The base station may configure a single CSI resource configuration and a single CSI report configuration for SD adaptation through higher layer signaling to the UE. Then, the base station may receive a CSI report from the UE based on the configured information. The base station may perform CSI reporting prediction considering various antenna patterns through the received CSI report. For example, when performing CSI reporting, the UE reports the entire measured channel matrix, and the base station may perform CSI reporting prediction through the CSI report. The base station may configure a single CSI resource configuration and a single CSI report configuration to the UE, and the UE may report a single CSI report based on this. The single CSI report may consider a single antenna pattern. The base station may predict CSI reporting for various antenna patterns based on the single CSI report received. Through this, the base station may determine the antenna pattern for each UE of SD adaptation for energy saving. According to Method 3 (1603) according to an embodiment, the CSI report received from the UE may include new information (e.g., full or partial channel matrix).

For example, the base station may configure a CSI resource corresponding to CSI-RS #0 through higher layer signaling. The UE may report CSI reporting #0 including the CSI measurement measured based on CSI-RS #0. CSI reporting #0 may be configured based on a specific ReportQuantity (e.g., cri-RI-PMI-CQI or a new measured channel matrix). Alternatively, it may include one or more of CQI. The base station may perform NES mode determination based on the reported CSI reporting #0.

According to Method 3 (1603) according to an embodiment, the configuration and measurement overhead for a CSI report may be reduced from the perspective of both the base station and the UE. [Method 4]-Single SRS resource based SD adaptation (1604)

According to Method 4 (1604) according to an embodiment, an SD adaptation method through SRS measurement may be provided. This may be for energy saving of the base station.

The base station may configure a single or multiple SRS resource (and/or SRS resource set) for SD adaptation through higher layer signaling to the UE. The UE may transmit SRS according to configuration information. The base station may determine antenna patterns for various SD adaptations through a single SRS measurement. In another method, the base station may determine antenna patterns for SD adaptation by measuring multiple SRS measurements each based on different Rx antenna patterns. That is, the base station may determine a plurality of antenna patterns for SD adaptation through a single SRS measurement obtained based on a single SRS resource. Alternatively, the base station may determine a plurality of antenna patterns for SD adaptation through multiple SRS measurements obtained based on multiple SRS resources. The base station may reidentify the determined antenna pattern by receiving CSI reporting from the UE through the determined antenna pattern. Through re-identification, the base station may fallback with the SD adaptation with a full antenna pattern in case where the L1-RSRP and/or CQI of the reported CSI report is low (e.g., in case of a certain threshold or less/less than a certain threshold). Otherwise (in case where the L1-RSRP and/or CQI of the reported CSI report are not low (e.g., in case of a certain threshold or greater/exceeding a certain threshold)), the base station may apply SD adaption (for each UE) by using the antenna pattern determined in advance through SRS measurement. The base station may determine the antenna pattern for SD adaptation for each UE through the SRS measurement.

For example, the base station may configure the SRS resource corresponding to SRS #0 through higher layer signaling. The UE may transmit SRS #0 based on the SRS resource. The base station may determine one or multiple antenna patterns based on SRS #0. The base station may transmit CSI-RS and receive CSI reporting corresponding to CSI-RS based on the determined antenna patterns. Additionally, the base station may determine the NES mode.

Method 4 (1604) according to an embodiment may consider reciprocity between DL and UL in a time division duplex (TDD) situation, for example. According to Method 4 (1604) according to an embodiment, the base station may determine SD adaptation only by receiving SRS without additional CSI transmission, so it may determine the SD adaptation with better energy efficiency. The UE may perform SRS transmission according to additional SRS configuration.

Hereinafter, a method for receiving CSI feedback for a base station to apply SD adaptation for each UE according to an embodiment is described. The CSI feedback reception method according to an embodiment may be applied in combination with the SD adaptation determination method according to the above-described embodiment.

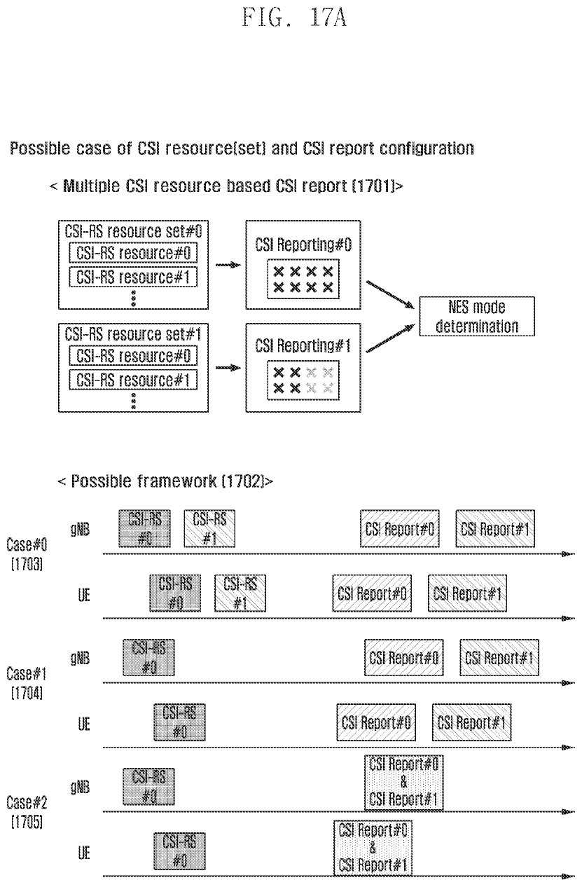

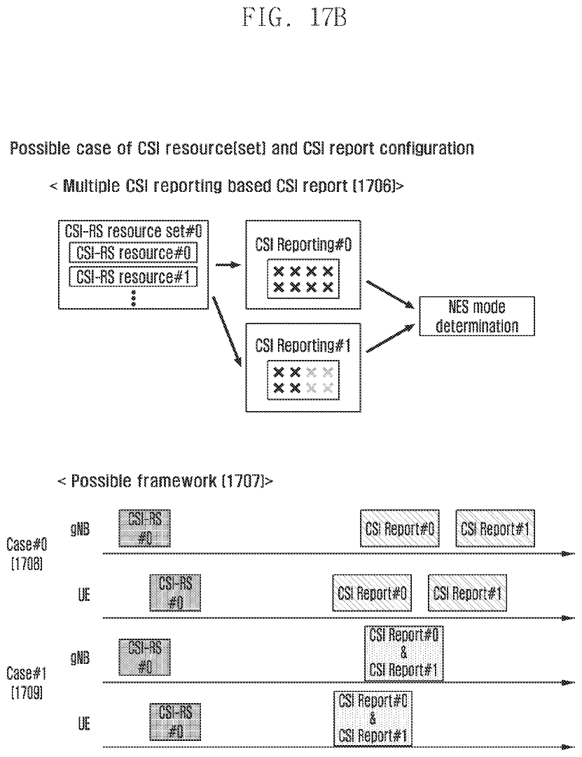

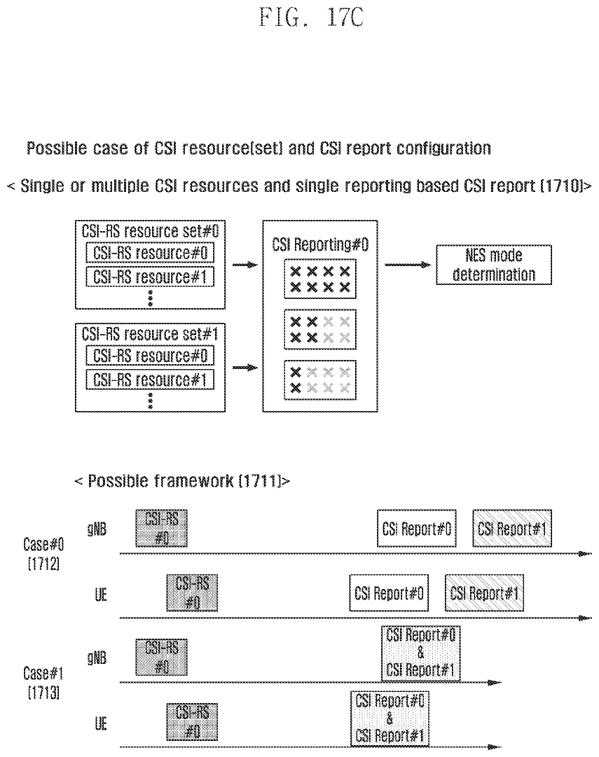

FIGS. 17A to 17C illustrate a CSI resource/resource set/report configuration methods for a base station to determine SD adaptation for each UE in a wireless communication system according to an embodiment of the disclosure.

With reference to FIGS. 17A to 17C, according to an embodiment, a CSI resource/resource set/report configuration method for a base station to determine SD adaptation for each UE based on CSI feedback for energy saving may be provided.

The base station may configure a CSI resource/resource set/report to determine an appropriate antenna pattern for SD adaptation for each UE using one or a combination of the following methods. The CSI resource/resource set/report configuration method according to an embodiment may be applied and the procedures of an SD adaptation determination method according to an embodiment may be performed.

### [Method 1]—Multiple CSI Resource Based CSI Report (1701)

According to Method 1 (1701) according to an embodiment, multiple CSI-RS resource/resource sets and multiple CSI reports may be configured. This may be for energy saving of the base station.

The base station may configure multiple CSI resource/resource sets through higher layer signaling for CSI report. The base station may configure multiple CSI reports for the CSI resource set. For example, each CSI report may have a single antenna structure hypothesis. The base station may determine an NES mode based on the multiple CSI reports received from the UE.

For example, the base station may configure CSI-RS resource set #0 and CSI-RS resource set #1, which include at least CSI-RS resource #0 and CSI-RS resource #1, respectively. Additionally, the base station may configure CSI Reporting #0 corresponding to CSI-RS resource set #0 and CSI Reporting #1 corresponding to CSI-RS resource set #1. CSI Reporting #0 and CSI Reporting #1 may each include a different antenna structure hypothesis. The base station may determine an NES mode based on the multiple CSI reports (corresponding to CSI Reporting #0 and CSI Reporting #1) received from the UE.

The base station and/or UE may perform at least some of the following operations through the multiple CSI resource/resource set and multiple CSI report configurations.

### [Operation 1]—Case #0

In Operation 1 (1703) according to an embodiment, the operations for CSI-RS transmission/measurement and CSI reporting through PUCCH/PUSCH may be performed in each different resource based on multiple CSI resource/resource set and multiple CSI report configurations.

The base station may configure multiple CSI resource/resource sets and multiple CSI reports to the UE through higher layer signaling. Then, the base station may transmit CSI-RSs with different CSI-RS patterns (e.g., different code domain multiplexing (CDM) groups) on different time/frequency resources, respectively. The UE may measure each CSI-RS transmitted from the base station and perform a CSI report through different PUCCH/PUSCH.

For example, the base station may transmit configuration information about the CSI resource/resource set corresponding to CSI-RS #0 and CSI resource/resource set corresponding to CSI-RS #1 through higher layer signaling, and the UE may receive the configuration information. The base station may transmit CSI-RS #0 and CSI-RS #1, and the UE may receive CSI-RS #0 and CSI-RS #1 based on the configuration information. Based on CSI-RS #0 and CSI-RS #1, the UE may transmit CSI Report #0 and CSI Report #1 through different PUCCH/PUSCH, respectively, and the base station may receive them.

### [Operation 2]—Case #1

In Operation 2 (1704) according to an embodiment, the operation for CSI-RS transmission/measurement and CSI reporting through different PUCCH/PUSCH may be performed in each same resource based on multiple CSI resource/resource set and multiple CSI report configuration. Hereinafter, unless specifically stated otherwise, in the disclosure, the same resource (or identical resource) may refer to time and frequency resources constituted inside a specific time interval (e.g., a single slot) (e.g., time and frequency resources for CSI (measurement), time and frequency resources at which CSI-RS is transmitted/mapped, CSI resources, etc.).

The base station may configure multiple CSI resource/resource sets and multiple CSI reports to the UE through higher layer signaling. Then, the base station may transmit CSI-RS with various CSI-RS patterns (e.g., different CDM groups) on the same resource. In this case, different CSI-RS patterns may have a sub-set structure. The UE may measure CSI-RS transmitted from the base station and perform CSI report of multiple CSI measurement values through different PUCCH/PUSCH, respectively.

For example, the base station may transmit configuration information about the CSI resource/resource set corresponding to CSI-RS #0 through higher layer signaling, and the UE may receive the configuration information. The base station may transmit CSI-RS #0, and the UE may receive CSI-RS #0 based on the configuration information. Based on CSI-RS #0, the UE may transmit CSI Report #0 and CSI Report #1 through different PUCCH/PUSCH, respectively, and the base station may receive them.

### [Operation 3]—Case #2

In Operation 3 (1705) according to an embodiment, the operation for single CSI-RS transmission/measurement and CSI reporting through a single PUCCH/PUSCH may be performed based on multiple CSI resource/resource set and multiple CSI report configurations.

The base station may configure multiple CSI resource/resource sets and multiple CSI reports to the UE through higher layer signaling. Then, the base station may transmit CSI-RS with various CSI-RS patterns (e.g., different CDM groups) on the same resource. In this case, different CSI-RS patterns may have a sub-set structure. The UE may measure the single CSI-RS transmitted from the base station based on various CSI report configuration information and perform the CSI report of multiple CSI measurement values through a single PUCCH/PUSCH.

For example, the base station may transmit configuration information about the CSI resource/resource set corresponding to CSI-RS #0 through higher layer signaling, and the UE may receive the configuration information. The base station may transmit CSI-RS #0, and the UE may receive CSI-RS #0 based on the configuration information. Based on CSI-RS #0, the UE may transmit CSI Report #0 and CSI Report #1 through the same PUCCH/PUSCH, and the base station may receive them.

Through at least some of the above operations, the base station may obtain the CSI report based on the multiple CSI resource/resource set and multiple CSI report configurations. That is, the base station may obtain the CSI report based on the multiple CSI resource/resource sets and multiple CSI report configurations.

### [Method 2]—Multiple CSI Report Based CSI Report (1706)

According to Method 2 (1706) according to an embodiment, a method for configuring a single CSI-RS resource/resourceset and multiple CSI reports may be provided. This may be for energy saving of the base station.

The base station may configure a single CSI resource/resourceset through higher layer signaling for a CSI report and configure multiple CSI reports for the CSI resourceset. For example, each CSI report may have a single antenna structure hypothesis. The base station may perform NES mode determination based on the multiple CSI reports received from the UE.

For example, the base station may configure CSI-RS resource set #0 including at least CSI-RS resource #0 and CSI-RS resource #1. Additionally, the base station may configure CSI Reporting #0 and CSI Reporting #1 corresponding to CSI-RS resource set #0. CSI Reporting #0 and CSI Reporting #1 may each include a different antenna structure hypothesis. The base station may perform NES mode determination based on the multiple CSI reports (corresponding to CSI Reporting #0 and CSI Reporting #1) received from the UE.

The base station and/or UE may perform at least some of the following operations through the single CSI resource/resource set and multiple CSI report configurations.

### [Operation 1]—Case #0

In Operation 1 (1708) according to an embodiment, the operation for CSI-RS transmission/measurement and CSI reporting through different PUCCH/PUSCH may be performed on each same resource based on a single CSI resource/resource set and multiple CSI report configurations.

The base station may configure a single CSI resource/resource set and multiple CSI reports to the UE through higher layer signaling. Then, the base station may transmit CSI-RS with various CSI-RS patterns (e.g., different CDM groups) on the same resource. In this case, different CSI-RS patterns may have a sub-set structure. The UE may measure CSI-RS transmitted from the base station and perform the CSI report of multiple CSI measurement values through different PUCCH/PUSCH, respectively.

For example, the base station may transmit configuration information about the CSI resource/resource set corresponding to CSI-RS #0 through higher layer signaling, and the UE may receive the configuration information. The base station may transmit CSI-RS #0, and the UE may receive CSI-RS #0 based on the configuration information. Based on CSI-RS #0, the UE may transmit CSI Report #0 and CSI Report #1 through different PUCCH/PUSCH, respectively, and the base station may receive them. [Operation 2]-Case #1

In Operation 2 (1709) according to an embodiment, the operation for a single CSI-RS transmission/measurement and CSI reporting through a single PUCCH/PUSCH may be performed based on a single CSI resource/resource set and multiple CSI report configurations. The base station may configure a single CSI resource/resource set and multiple CSI reports to the UE through higher layer signaling. Then, the base station may transmit CSI-RS with various CSI-RS patterns (e.g., different CDM groups) on the same resource. In this case, different CSI-RS patterns may have a sub-set structure. The UE may measure the single CSI-RS transmitted from the base station based on various CSI report configuration information and perform the CSI report of multiple CSI measurement values through a single PUCCH/PUSCH.

For example, the base station may transmit configuration information about the CSI resource/resource set corresponding to CSI-RS #0 through higher layer signaling, and the UE may receive the configuration information. The base station may transmit CSI-RS #0, and the UE may receive CSI-RS #0 based on the configuration information. Based on CSI-RS #0, the UE may transmit CSI Report #0 and CSI Report #1 through the same PUCCH/PUSCH, and the base station may receive them.

Through at least some of the above operations, the base station may obtain a CSI report based on the single CSI resource/resource set and multiple CSI report configurations. That is, the base station may obtain a CSI report based on the single CSI resource/resource set and multiple CSI report configurations.

### [Method 3]—Single or Multiple CSI Resources and Single Reporting Based CSI Report (1710)

According to Method 3 (1710) according to an embodiment, a method for configuring a single CSI report with a single or multiple CSI-RS resource/resource set and multiple antenna structure hypotheses may be provided. This may be for energy saving of the base station.

The base station may configure a single or multiple CSI resource/resource set through higher layer signaling for a CSI report and configure a single CSI report with multiple antenna structure hypotheses for the CSI resource set. The base station may determine an NES mode based on the single CSI report received from the UE.

For example, the base station may configure CSI-RS resource set #0 and CSI-RS resource set #1, which include at least CSI-RS resource #0 and CSI-RS resource #1, respectively. Additionally, the base station may configure CSI Reporting #0 corresponding to CSI-RS resource set #0 and CSI-RS resource set #1. CSI Reporting #0 may have multiple antenna structure hypotheses. The base station may determine an NES mode based on the single CSI report (corresponding to CSI Reporting #0) received from the UE.

The base station may perform at least some of the following operations through the single CSI resource/resource set and CSI report configuration with multiple antenna structure hypotheses.

### [Operation 1]—Case #0

In Operation 1 (1712) according to an embodiment, the operation for CSI-RS transmission/measurement and CSI reporting through different PUCCH/PUSCH may be performed on each same resource based on a single CSI resource/resource set and a single CSI report configuration with multiple antenna structure hypotheses. For example, the single CSI report configuration may include multiple antenna structure hypotheses.

The base station may configure the single CSI resource/resource set and the single CSI report with multiple antenna structure hypotheses to the UE through higher layer signaling. Then, the base station may transmit CSI-RS with various CSI-RS patterns (e.g., different CDM groups) on the same resource. In this case, different CSI-RS patterns may have a sub-set structure. The UE may measure the CSI-RS transmitted from the base station and perform the CSI report of multiple CSI measurement values through different PUCCH/PUSCH, respectively.

For example, the base station may transmit configuration information about the CSI resource/resource set corresponding to CSI-RS #0 through higher layer signaling, and the UE may receive the configuration information. The base station may transmit one CSI Reporting #0 including different antenna structure hypotheses (e.g., three), and the UE may receive it. The base station may transmit CSI-RS #0, and the UE may receive CSI-RS #0 based on the configuration information. Based on CSI-RS #0, the UE may transmit CSI Report #0 and CSI Report #1 through different PUCCH/PUSCH, respectively, and the base station may receive them. CSI Report #0 and CSI Report #1 may be based on the CSI Reporting #0 configuration and may each correspond to one of the different antenna structure hypotheses included in CSI Reporting #0.

### [Operation 2]—Case #1

In Operation 2 (1713) according to an embodiment, the operation for single CSI-RS transmission/measurement and a CSI reporting through a single PUCCH/PUSCH may be performed based on a single CSI resource/resource set and a single CSI report configuration with multiple antenna structure hypotheses.

The base station may configure a single CSI resource/resource set and a single CSI report with multiple antenna structure hypotheses to the UE through higher layer signaling. Then, the base station may transmit CSI-RS with various CSI-RS patterns (e.g., different CDM groups) on the same resource. In this case, different CSI-RS patterns may have a sub-set structure. The UE may measure the single CSI-RS transmitted from the base station based on various CSI report configuration information (e.g., antenna structure hypotheses) and perform the CSI report of multiple CSI measurement values through a single PUCCH/PUSCH. In Operation 2, the base station may transmit through one or more PUCCH/PUSCH considering the size of the CSI report measured based on multiple antenna structure hypotheses.

For example, the base station may transmit configuration information about the CSI resource/resource set corresponding to CSI-RS #0 through higher layer signaling, and the UE may receive the configuration information. The base station may transmit one CSI Reporting #0 including different antenna structure hypotheses (e.g., three), and the UE may receive it. The base station may transmit CSI-RS #0, and the UE may receive CSI-RS #0 based on the configuration information. Based on CSI-RS #0, the UE may transmit CSI Report #0 and CSI Report #1 through the same PUCCH/PUSCH, and the base station may receive them. CSI Report #0 and CSI Report #1 may be based on the CSI Reporting #0 configuration and may each correspond to one of the different antenna structure hypotheses included in CSI Reporting #0.

Through at least some of the above operations, the base station may obtain the CSI report based on the single CSI resource/resource set and the single CSI report configuration. That is, the base station may obtain the CSI report corresponding to the single CSI resource/resource set and single CSI report configuration.

In Method 3 according to an embodiment, the base station may configure a CSI report to determine SD adaptation through Configuration 1 below. This may be for energy saving.

### [Configuration 1]

In Configuration 1 according to an embodiment, a method for the base station to configure CSI report configuration information to determine SD adaptation for energy saving to the UE in RRC connected state may be performed.

The base station may configure CSI report configuration information to determine SD adaptation to the UE. For example, this may be configured for the UE in RRC connected/inactive state. This may be for energy saving of the base station.

For example, CodebookConfig of CSI-reportConfig as shown in Table 13 may be configured through RRC signaling.

```
TABLE 13
CodebookConfig ::= SEQUENCE {
  CodebookConfig-r18 ::= SEQUENCE {
    AdaptationType CHOICE {Type 1, Type 2},
      Active_duration INTEGER (1..31),
      NES-Threshold CHOICE {rsrp-Threshold, CQI index},
      Type2-SD-Adaptation {
          PowerControlOffsetSS ENUMERATED {db−3, db0, db3,
  db6},
          typeII-r16 SEQUENCE {
            Multi-n1-n2-codebookSubsetRestriction-r16
            ENUMERATED {
              two-one BIT STRING (SIZE (16)),
              two-two BIT STRING (SIZE (43)),
              four-one BIT STRING (SIZE (32)),
              three-two BIT STRING (SIZE (59)),
  ...
  },
  Nrofmulti-n1-n2-codebook ENUMERATED {1, 2, 3, 4},...
  }
...
```

The base station may configure a CSI report with the multiple antenna structure hypotheses of the base station for SD adaptation during an NES mode through the CodebookConfig RRC configuration. In this case, at least some of information about the type of SD adaptation, active_duration information for applying measurement based on the multiple antenna structure hypotheses, NES-Threshold for determining a selective antenna structure among the multiple antenna structure hypotheses, PowerControlOffsetSS value, and the number of CSI reports that can be CSI reported among the multiple antenna structure hypotheses, Nrofmulti-n1-n2-codebook, may be configured as new information. The value of the RRC may be configured in various ways as an example.

According to an embodiment, a CSI resource/resource set/report configuration method and configuration-based CSI-RS transmission and CSI report framework may be provided. Through this, the base station may receive CSI feedback for SD adaptation for each UE. According to an embodiment, less performance degradation and energy saving effects can be obtained.

According to an embodiment, a threshold-based selected CSI report method may be provided to improve the overhead of the CSI report operation for determining SD adaptation for energy saving of the base station. The UE may identify the CSI measurement results and then determine a CSI report selection method based on the base station's configuration information. The UE may perform a selected CSI report method based on the CSI measurement results. Additionally, the selected CSI report method may be applied differently depending on an SD adaptation type. The selected CSI report method according to an embodiment may be applied in combination with at least some of the SD adaptation determination method according to an embodiment and the CSI resource/resource set/report configuration method according to an embodiment.

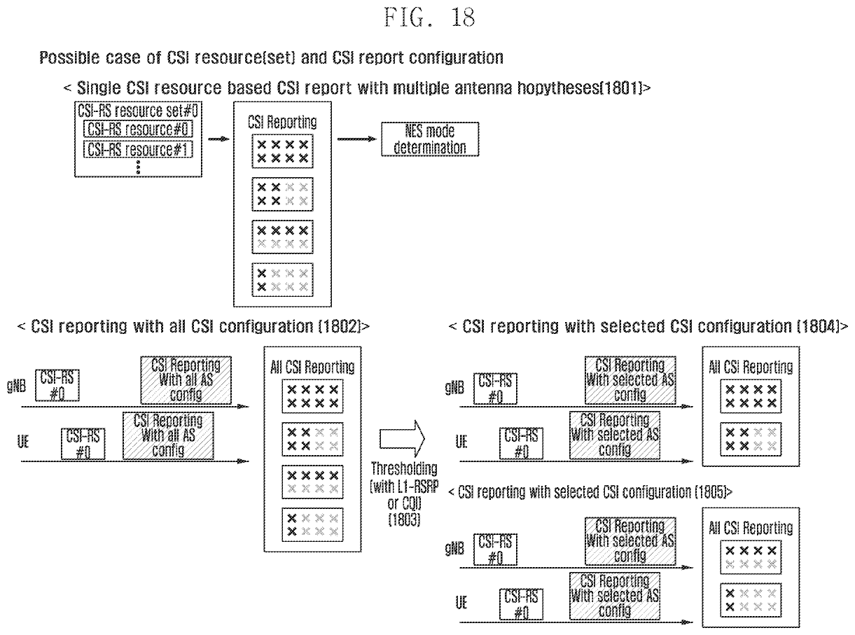

FIG. 18 illustrates a selected CSI report method according to an SD adaptation type for energy saving of a base station in a wireless communication system according to an embodiment of the disclosure.

With reference to FIG. 18, in order to apply Type 1 SD adaptation, the base station may configure a single or multiple CSI resource/resource set and a single CSI report with multiple antenna structure hypotheses through higher layer signaling (1801). For example, the base station may configure a CSI report assuming four antenna structure hypotheses in a single CSI resource/resource set (e.g., CSI-RS resource set #0 including CSI-RS resource #0 and CSI-RS resource #1). The base station may transmit a single CSI-RS (e.g., CSI-RS #0 corresponding to CSI-RS resource set #0) based on the configured information. CSI information measured by considering four different antenna structure hypotheses may be reported through one PUCCH/PUSCH transmission (1802).

The UE may incur overhead in having to perform CSI measurement by considering four different antenna structures using a single CSI-RS. Additionally, the CSI reporting size may be quadrupled, increasing feedback overhead. To solve this, the base station may configure a threshold (L1-RSRP or CQI index) when configuring the CSI resource/resource set and CSI report (1803). The UE may select antenna structure hypotheses (i.e., appropriate for SD adaptation) for CSI report using the configured threshold.

For example, in case of receiving L1-RSRP configured as a threshold value from the base station, the UE may consider PowerControlOffset and compare L1-RSRP through CSI-RS (e.g., CSI-RS #0) with the configured threshold L1-RSRP. In case where the L1-RSRP measured through CSI-RS (e.g., CSI-RS #0) is smaller than the threshold, the UE may report two CSI reports using an antenna structure (or pattern) with more active antennas (1804).

On the other hand, in case where the L1-RSRP measured through CSI-RS (e.g., CSI-RS #0) is greater than the threshold, the UE may determine that a channel is good and report two CSI reports using an antenna structure (or pattern) with fewer active antennas (1805).

For example, in case of receiving CQI configured as a threshold value from the base station, the UE may compare the CQI through CSI-RS (e.g., CSI-RS #0) with the configured threshold CQI. In case where the CQI measured through CSI-RS (e.g., CSI-RS #0) is smaller than the threshold CQI, the UE may report two CSI reports using an antenna structure (or pattern) with more active antennas.

On the other hand, in case where the CQI measured through CSI-RS (e.g., CSI-RS #0) is greater than the threshold CQI, the UE may determine that a channel is good and report two CSI reports using an antenna structure (or pattern) with fewer active antennas.

The number of antenna structure (or pattern) hypotheses to be selected in the CSI report may be configured by the base station or determined through UE capability. For example, UE capability may be the maximum number of CSI reporting possible during processing time (e.g., CSI processing unit) for CSI reporting. The base station may manage the size of the selected CSI report for decoding the CSI report.

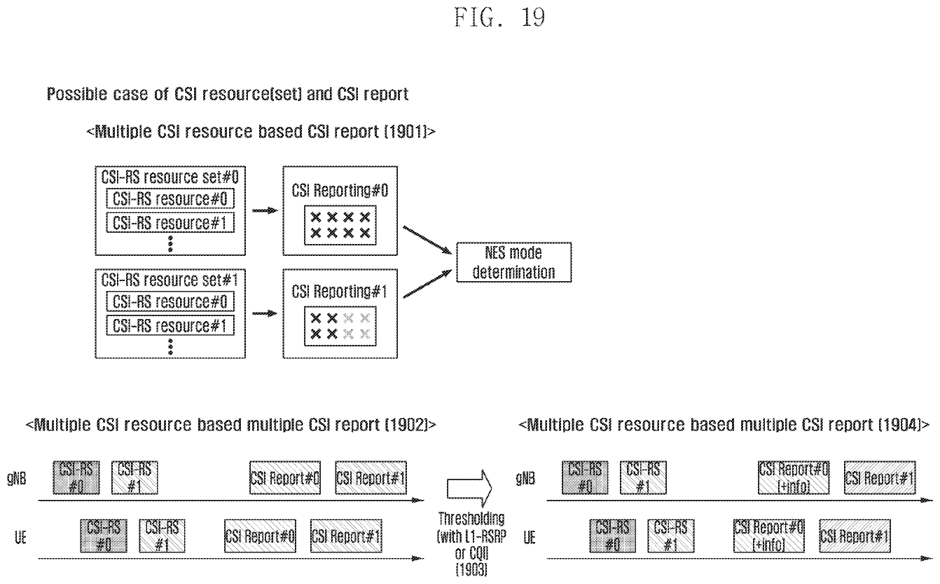

FIG. 19 illustrates a selected CSI report method according to an SD adaptation type for energy saving of a base station in a wireless communication system according to an embodiment of the disclosure.

With reference to FIG. 19, in order to apply the Type 2 SD adaptation, the base station may configure multiple CSI resource/resource sets and multiple CSI reports through higher layer signaling (1901). For example, the base station may configure two CSI reports to two CSI resource/resource sets (CSI-RS resource set #0 and CSI-RS resource set #1 including at least CSI-RS resource #0 and CSI-RS resource #1, respectively). Each CSI resource may receive the configuration for different nrofport and PowerControlOffset values. The base station may transmit CSI-RSs (CSI-RS #0 and CSI-RS #1) in different time/frequency resources based on the configured information. Each measured CSI measurement value may be reported (CSI Report #0, CSI Report #1) through PUCCH/PUSCH transmission (1902).

The UE may incur overhead of performing CSI measurement twice and transmitting CSI report twice using two CSI-RSs. To solve this, the base station may configure a threshold (L1-RSRP or CQI index) when configuring the CSI resource/resource set and CSI report (1903). The UE may select a CSI report (i.e., appropriate for SD adaptation) for CSI report using the configured threshold.

For example, in case of receiving L1-RSRP configured as a threshold value from the base station, the UE may consider PowerControlOffset and compare L1-RSRP through a CSI-RS with a full antenna structure among the plurality of configured CSI-RSs with the configured threshold L1-RSRP. In case where the L1-RSRP measured through CSI-RS is smaller than the threshold, CSI reporting #0 with more active antennas may be transmitted.

On the other hand, in case where the L1-RSRP measured through CSI-RS is greater than the threshold, the UE may determine that a channel is good and transmit both CSI reporting #0 and CSI reporting #1 for SD adaptation (1904).

For example, in case of receiving a CQI configured as a threshold value from the base station, the UE may compare the CQI through CSI-RS (e.g., CSI-RS #0) with the configured threshold CQI. In case where the CQI measured through CSI-RS is smaller than the threshold CQI, the UE may transmit CSI reporting #0 with more active antennas.

On the other hand, in case where the CQI measured through CSI-RS (e.g., CSI-RS #0) is greater than the threshold CQI, the UE may determine that a channel is good and transmit both CSI reporting #0 and CSI reporting #1.

The UE may transmit information (e.g., bitmap) indicating whether CSI Report #1 is transmitted through CSI Report #0, and the base station may identify whether CSI Report #1 is transmitted through this. That is, the base station may receive, from the UE, additional information (e.g., bitmap) to determine whether to transmit CSI reporting #1 to be transmitted after CSI Report #0, through CSI reporting #0. For example, if bitmap=“10” is configured, it may be determined that only CSI reporting #0 is transmitted and CSI reporting #1 is not transmitted. For example, if bitmap=“11” is configured, both CSI reporting #0 and CSI reporting #1 may be transmitted. Alternatively, the bitmap may be configured to 1 bit corresponding to CSI reporting #1. For example, if the bit value is 0, CSI reporting #1 may not be transmitted, and if the bit value is 1, CSI reporting #1 may be transmitted.

Through the selected CSI report method according to an embodiment, the selected CSI reporting method according to the SD adaptation type may be applied. Accordingly, by reducing the overhead of CSI reporting, the energy saving effect of both the base station and UE may be achieved and the complexity of the base station and UE may be reduced. The threshold described above is an example and is not limited to L1-RSRP/CQI. For example, L3-RSRP and L1/L3-RSRQ may be applied as the threshold. Additionally, the selected CSI report may be indicated in the CQI table as shown in Table 14.

TABLE 1
4-bit CQI Table with selected CSI report

| CQI index | modulation | code rate × 1024 | efficiency | sCSI report |
|---|---|---|---|---|
| 0 | out of range | | | 0~2 |
| 1 | QPSK | 78 | 0.1523 | 0~2 |
| 2 | QPSK | 120 | 0.2344 | 0~2 |
| 3 | QPSK | 193 | 0.3770 | 3, 4 |
| 4 | QPSK | 308 | 0.6016 | 3, 4 |
| 5 | QPSK | 449 | 0.8770 | 3, 4 |
| 6 | QPSK | 602 | 1.1758 | 5, 6 |
| 7 | 16QAM | 378 | 1.4766 | 5, 6 |
| 8 | 16QAM | 490 | 1.9141 | 5, 6 |
| 9 | 16QAM | 616 | 2.4063 | 5, 6 |
| 10 | 64QAM | 466 | 2.7305 | 7, 8, 9 |
| 11 | 64QAM | 567 | 3.3223 | 7, 8, 9 |
| 12 | 64QAM | 666 | 3.9023 | 7, 8, 9 |
| 13 | 64QAM | 772 | 4.5234 | 10 |
| 14 | 64QAM | 873 | 5.1152 | 10 |
| 15 | 64QAM | 948 | 5.5547 | 10 |

According to an embodiment, a selected CSI report transmission and reception procedure may be provided for energy saving of the base station and for determining SD adaptation of the base station and UE. Hereinafter, the flowchart and block diagram of the UE and base station for configuring CSI resource/resource set/report and determining selected CSI report are described.

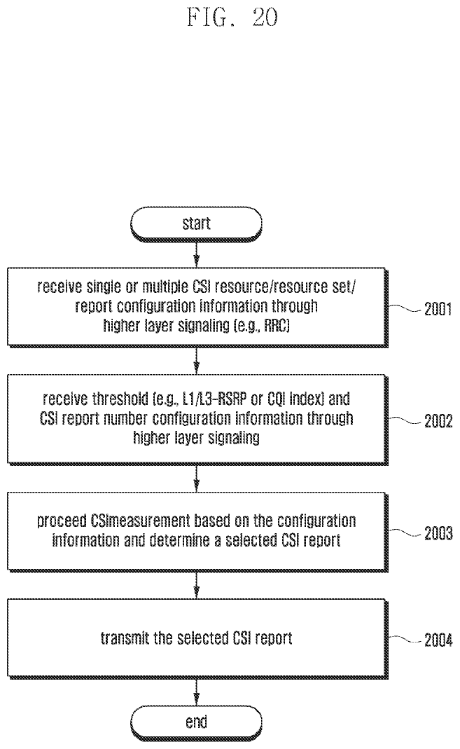

FIG. 20 illustrates a flowchart for describing the operation of the UE that applies an energy saving method of a wireless communication system according to an embodiment of the disclosure.

In operation 2001, the UE may receive CSI configuration information from the base station through higher layer signaling (e.g., RRC). For example, single or multiple CSI resource/resource set/report configuration information may be received. The CSI configuration information may be necessary for the base station to determine SD adaptation for energy saving of the base station.

In operation 2002, the UE may receive a threshold (e.g., L1/L3-RSRP or CQI index) and CSI report number configuration information through higher layer signaling for selected CSI reporting.

In operation 2003, the UE may proceed with CSI measurement based on the configuration information and determine the selected CSI report through the threshold. In operation 2004, the UE may transmit the selected CSI report.

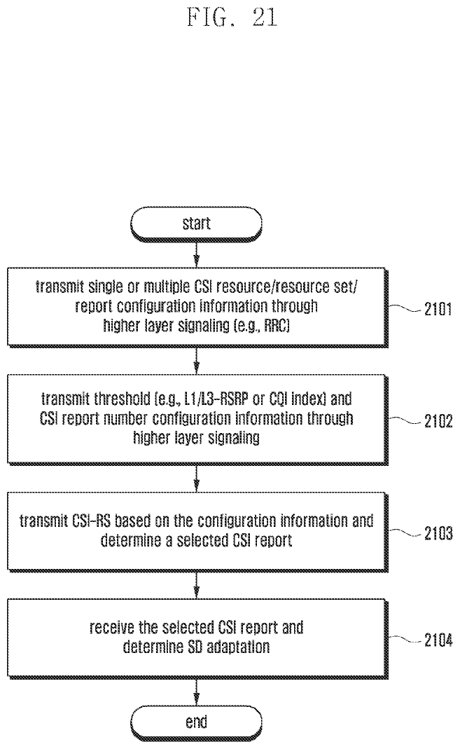

FIG. 21 illustrates a flowchart for describing the operation of the base station that applies an energy saving method of a wireless communication system according to an embodiment of the disclosure.

In operation 2101, the base station may transmit CSI configuration information to the UE through higher layer signaling (e.g., RRC). For example, single or multiple CSI resource/resourceset/report configuration information may be transmitted. CSI configuration information may be necessary for the base station to determine SD adaptation for energy saving of the base station.

In operation 2102, the base station may transmit threshold (e.g., L1/L3-RSRP or CQI index) and CSI report number configuration information through higher layer signaling for selected CSI reporting.

In operation 2103, the base station may transmit a CSI-RS based on the configuration information (or related to the configuration information) and determine a selected CSI report.

In operation 2104, the base station may receive the selected CSI report and determine SD adaptation for each UE.

The above flowcharts illustrate example methods that can be implemented in accordance with the principles of the disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

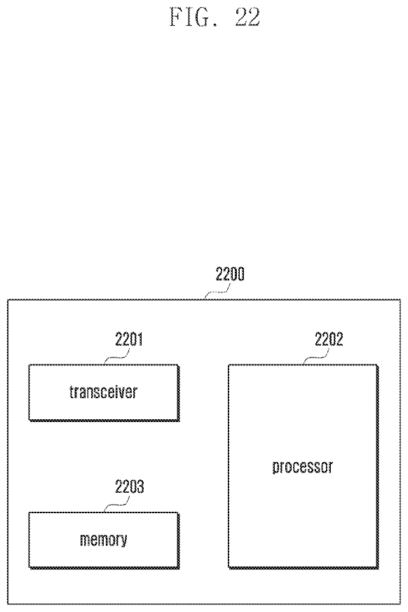

FIG. 22 illustrates a UE according to an embodiment of the disclosure.

With reference to FIG. 22, a UE 2200 may include a transceiver 2201, a controller (e.g., processor) 2202, and a storage (e.g., memory) 2203. The transceiver 2201, controller 2202, and storage 2203 of the UE 2200 may be operated according to at least one or a combination of the methods corresponding to the above-described embodiments. However, the components of the UE 2200 are not limited to the shown examples. According to another embodiment, the UE 2200 may include more or fewer components than the above-described components. Additionally, in certain cases, the transceiver 2201, the controller 2202, and the storage 2203 may be implemented in the form of a single chip.

According to an embodiment, the transceiver 2201 may include a transmitter and a receiver. The transceiver 2201 may transmit/receive signals to/from the base station. The signals may include control information and data. The transceiver 2201 may be constituted to include an RF transmitter for up-converting and amplifying the frequency of signals transmitted, and an RF receiver for low-noise amplifying signals received and down converting the frequency of the received signals. The transceiver 2201 may receive signals via a radio channel, output the signals to the controller 2202, and transmit signals output from the controller 2202 via a radio channel.

The controller 2202 may control a series of procedures for the UE 2200 to be able to operate according to the above-described embodiments. For example, the controller 2202 may perform or control the operations of the UE to perform at least one or a combination of the methods according to embodiments of the disclosure. The controller 2202 may include at least one processor. For example, the controller 2202 may include a communication processor (CP) that performs control for communication and an application processor (AP) that controls a higher layer (e.g., an application).

The storage 2203 may store control information (e.g., information related to channel estimation using DMRSs transmitted in the PUSCH included in the signal obtained by the UE 2200) or data and may have an area for storing data necessary for control by the controller 2202 and data generated when controlled by the controller 2202.

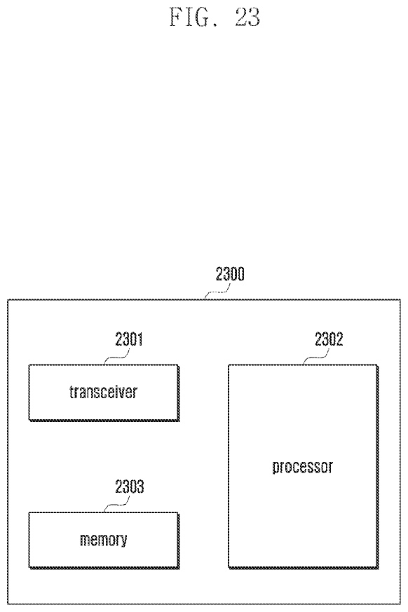

FIG. 23 illustrates a base station according to an embodiment.

With reference to FIG. 23, a base station 2300 may include a transceiver 2301, a controller (e.g., processor) 2302, and a storage (e.g., memory) 2303. The transceiver 2301, controller 2302, and storage 2303 of the base station 2300 may be operated according to at least one or a combination of the methods corresponding to the above-described embodiments. However, the components of the base station 2300 are not limited to the shown examples. According to another embodiment, the base station 2300 may include more or fewer components than the above-described components. Additionally, in certain cases, the transceiver 2301, the controller 2302, and the storage 2303 may be implemented in the form of a single chip.

According to an embodiment, the transceiver 2301 may include a transmitter and a receiver. The transceiver 2301 may transmit/receive signals to/from the UE. The signals may include control information and data. The transceiver 2301 may be constituted to include an RF transmitter for frequency-up converting and amplifying signals transmitted and an RF receiver for low-noise amplifying signals received and down converting the frequency of the received signals. The transceiver 2301 may receive signals via a radio channel, output the signals to the controller 2302, and transmit signals output from the controller 2302 via a radio channel.

The controller 2302 may control a series of procedures for the base station 2300 to be able to operate according to the above-described embodiments, example, the controller 2302 may perform or control the operations of the base station to perform at least one or a combination of the methods according to embodiments of the disclosure. The controller 2302 may include at least one processor. For example, the controller 2302 may include a communication processor (CP) that performs control for communication and an application processor (AP) that controls a higher layer (e.g., an application).

The storage 2303 may store control information (e.g., information related to channel estimation, generated using DMRSs transmitted in the PUSCH determined by the base station 2300), data, or control information or data received from the UE and may have an area for storing data necessary for control by the controller 2302 and data generated when controlled by the controller 2302.

Although the figures illustrate different examples of user equipment/base station, various changes may be made to the figures. For example, the user equipment/base station can include any number of each component in any suitable arrangement. In general, the figures do not limit the scope of this disclosure to any particular configuration. Moreover, while figures illustrate operational environments in which various user equipment/base station features disclosed in this patent document can be used, these features can be used in any other suitable system.

Although the disclosure has been described with exemplary embodiments, various changes and modifications may be suggested to one skilled in the art. It is intended that the disclosure encompass such changes and modifications as fall within the scope of the appended claims. None of the description in this application should be read as implying that any particular element, step, or function is an essential element that must be included in the claims scope. The scope of patented subject matter is defined by the claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a base station in a communication system, the method comprising:
transmitting, to a user equipment (UE), a configuration of a channel state information (CSI) report, wherein the CSI report includes a plurality of subsets of CSI reference signal (CSI-RS) antenna ports;
receiving, from the UE, the CSI report including at least one measurement value associated with at least one subset among the plurality of subsets of the CSI-RS antenna ports; and
identifying a number of activated transmitter receiver units (TXRUs) based on the at least one measurement value.

2. The method of claim 1, wherein a number of the at least one subset is associated with capability of the UE for a CSI processing unit (CPU) associated with the CSI report.

3. The method of claim 1, wherein the configuration of the CSI report includes a plurality of power control offsets corresponding to the plurality of subsets of the CSI-RS antenna ports, and
wherein a power control offset of the plurality of power control offsets is configured for a measurement value associated with a subset corresponding to the power control offset.

4. The method of claim 1, wherein the number of activated TXRUs is identified based on:
adjusting a number of antenna ports with maintaining a number of activated physical antenna elements per antenna port in case that the base station is configured to operate in a mode 1,
adjusting a number of activated physical antenna elements with maintaining the number of antenna ports in case that the base station is configured to operate in a mode 2, and
wherein the configuration of the CSI report includes information associated with whether the base station is configured to operate in the mode 1 or the mode 2.

5. The method of claim 1, wherein the at least one measurement value comprises at least one of reference signal received power (RSRP), reference signal received quality (RSRQ), or a channel quality indicator (CQI).

6. A base station in a communication system, the base station comprising:
a transceiver; and
a processor coupled with the transceiver and configured to:
transmit, to a user equipment (UE), a configuration of a channel state information (CSI) report, wherein the CSI report includes a plurality of subsets of CSI reference signal (CSI-RS) antenna ports;
receive, from the UE, the CSI report including at least one measurement value associated with at least one subset among the plurality of subsets of the CSI-RS antenna ports; and
identify a number of activated transmitter receiver units (TXRUs) based on the at least one measurement value.

7. The base station of claim 6, wherein a number of the at least one subset is associated with capability of the UE for a CSI processing unit (CPU) associated with the CSI report.

8. The base station of claim 6, wherein the configuration of the CSI report includes a plurality of power control offsets corresponding to the plurality of subsets of the CSI-RS antenna ports, and
wherein a power control offset of the plurality of power control offsets is configured for a measurement value associated with a subset corresponding to the power control offset.

9. The base station of claim 6, wherein the number of activated TXRUs is identified based on:
adjusting a number of antenna ports with maintaining a number of activated physical antenna elements per antenna port in case that the base station is configured to operate in a mode 1,
adjusting a number of activated physical antenna elements with maintaining the number of antenna ports in case that the base station is configured to operate in a mode 2, and
wherein the configuration of the CSI-RS report includes information associated with whether the base station is configured to operate in the mode 1 or the mode 2.

10. The base station of claim 6, wherein the at least one measurement value comprises at least one of reference signal received power (RSRP), reference signal received quality (RSRQ), or a channel quality indicator (CQI).

11. A method performed by a user equipment (UE) in a communication system, the method comprising:
receiving, from a base station, a configuration of a channel state information (CSI) report, wherein the CSI report includes a plurality of subsets of CSI reference signal (CSI-RS) antenna ports;
identifying at least one measurement value associated with at least one subset among the plurality of subsets of the CSI-RS antenna ports; and
transmitting, to the base station, the CSI report including the at least one measurement value,
wherein the at least one measurement value is associated with a number of activated transmitter receiver units (TXRUs) of the base station.

12. The method of claim 11, wherein a number of the at least one subset is identified based on capability of the UE for a CSI processing unit (CPU) associated with the CSI report.

13. The method of claim 11, wherein the configuration of the CSI report includes a plurality of power control offsets corresponding to the plurality of subsets of the CSI-RS antenna ports, and
wherein a power control offset of the plurality of power control offsets is identified for a measurement value associated with a subset corresponding to the power control offset.

14. The method of claim 11, wherein the configuration of the CSI report includes information associated with a mode 1 or a mode 2,
wherein, in case that the information is associated with the mode 1, the number of activated TXRUs is associated with a number of antenna ports being adjusted with a number of activated physical antenna elements per antenna port being maintained, and
wherein, in case that the information is associated with the mode 2, a number of activated physical antenna elements being adjusted with the number of antenna ports being maintained.

15. The method of claim 11, wherein the at least one measurement value comprises at least one of reference signal received power (RSRP), reference signal received quality (RSRQ), or a channel quality indicator (CQI).

16. A user equipment (UE) in a communication system, the UE comprising:
a transceiver; and
a processor coupled with the transceiver and configured to:
receive, from a base station, a configuration of a channel state information (CSI) report, wherein the CSI report includes a plurality of subsets of CSI reference signal (CSI-RS) antenna ports;
identify at least one measurement value associated with at least one subset among the plurality of subsets of the CSI-RS antenna ports; and
transmit, to the base station, the CSI report including the at least one measurement value,
wherein the at least one measurement value is associated with a number of activated transmitter receiver units (TXRUs) of the base station.

17. The UE of claim 16, wherein a number of the at least one subset is identified based on capability of the UE for a CSI processing unit (CPU) associated with the CSI report.

18. The UE of claim 16, wherein the configuration of the CSI report includes a plurality of power control offsets corresponding to the plurality of subsets of the CSI-RS antenna ports, and
Wherein a power control offset of the plurality of power control offsets is identified for a measurement value associated with a subset corresponding to the power control offset.

19. The UE of claim 16, wherein the configuration of the CSI report includes information associated with a mode 1 or a mode 2,
wherein, in case that the information is associated with the mode 1, the number of activated TXRUs is associated with a number of antenna ports being adjusted with a number of activated physical antenna elements per antenna port being maintained, and
wherein, in case that the information is associated with the mode 2, a number of activated physical antenna elements being adjusted with the number of antenna ports being maintained.

20. The UE of claim 16, wherein the at least one measurement value comprises at least one of reference signal received power (RSRP), reference signal received quality (RSRQ), or a channel quality indicator (CQI).
